(19) United States
(12) Patent Application Publication
(10) Pub. No.: US 2026/0065940 A1
(43) Pub. Date: Mar. 5, 2026

(54) VIDEO GENERATION METHOD, APPARATUS, DEVICE, MEDIUM, PRODUCT

(71) Applicant: Beijing Zitiao Network Technology Co., Ltd., Beijing (CN)

(72) Inventor: Qingwen HU, Beijing (CN)

(21) Appl. No.: 19/307,295

(22) Filed: Aug. 22, 2025

(30) Foreign Application Priority Data
Aug. 28, 2024 (CN) 202411196275.7

(51) Int. Cl. G11B 27/031; G06T 7/11; G06T 7/55

(52) U.S. Cl. CPC G11B 27/031; G06T 7/11; G06T 7/55; G06T 2207/10016; G06T 2207/20081; G06T 2207/20084; G06T 2207/30196

(57) ABSTRACT

The disclosure discloses a video generation method, an apparatus, a device, a medium and a product. The method comprises: firstly, obtaining a first video so that at least one frame image in the first video includes a target object; then, for any frame image in the first video, performing body shape parameter prediction processing on the image to obtain the body shape parameter prediction result corresponding to the image, and performing adjustment processing on the body shape parameter prediction result corresponding to the image based on the body shape adjustment information specified for the target object to obtain the body shape parameter adjustment result corresponding to the image; finally, generating a second video based on the first video and the body shape parameter adjustment result corresponding to at least one image in the first video.

### CROSS-REFERENCE TO RELATED APPLICATION(S)

This application claims priority to Chinese Application No. 202411196275.7 filed on Aug. 28, 2024, the disclosure of which is incorporated herein by reference in its entirety.

### FIELD

The present application relates to the field of computer technology, and in particular to a video generation method, apparatus, device, medium, and product.

### BACKGROUND

For some application scenarios, such as video shooting scenarios, video beautification scenarios, or video modification scenarios, these scenarios have the following requirements: for an object presented in a video, such as a human or an avatar, perform body shape adjustments, such as overall slimming or overall fattening.

### SUMMARY

In order to achieve the above objectives, the technical solutions provided by this application are as follows.

The present application provides a video generation method, the method comprises: obtaining a first video, at least one frame image in the first video includes a target object; for any frame image in the first video, performing body shape parameter prediction processing on the image to obtain a body shape parameter prediction result corresponding to the image, the body shape parameter prediction result is used to describe the body shape of the target object in the image; for any frame image in the first video, obtaining a body shape parameter adjustment result corresponding to the image by performing adjustment processing on the body shape parameter prediction result corresponding to the image according to body shape adjustment information specified for the target object; generating a second video according to the first video and a body shape parameter adjustment result corresponding to the at least one frame image in the first video, the i-th frame image in the second video is used to represent the body shape adjustment result for the i-th frame image in the first video, the i-th frame image in the second video is generated according to a plurality of frame images arranged in sequence in the first video and the body shape parameter adjustment results corresponding to the plurality of frame images, and a distance between an arrangement position of at least one frame image of the plurality of frame images in the first video and an arrangement position of the i-th frame image in the first video is not greater than a preset distance threshold, i is a positive integer, and i is less than or equal to a number of image frames in the second video or a number of image frames in the first video.

In one possible implementation, the body shape described by the i-th frame image in the second video is different from the body shape described by the i-th frame image in the first video, and other information except for the body shape described by the i-th frame image in the second video is consistent with other information except for the body shape described by the i-th frame image in the first video.

In a possible implementation manner, the body shape parameter prediction result corresponding to at least one frame image in the second video remains consistent.

In one possible implementation, the second video is generated using a target model; the target model comprises at least one processing unit, the processing unit includes an image-level processing module and a time sequence module, the image-level processing module is used to separately implement a separate processing procedure for at least one frame image of the multiple frame images, and the time sequence module is configured to perform attention processing on the execution results of the separate processing procedures for the multiple frame images in the time direction.

In one possible implementation, the at least one processing unit comprises multiple up-sampling modules, a time sequence module corresponding to at least one of the up-sampling modules, multiple down-sampling modules, and a time sequence module corresponding to at least one of the down-sampling modules; for any up-sampling module of the up-sampling modules, a time sequence module corresponding to the up-sampling module is configured to perform attention processing on output data of the up-sampling module in the time direction; for any down-sampling module of the down-sampling modules, a time sequence module corresponding to the down-sampling module is configured to perform attention processing on output data of the down-sampling module in the time direction.

In one possible implementation, the attention processing is also implemented according to the time information of at least one frame image of the multiple frames; for any frame image of the multiple frames, the time information of the frame image is configured to describe the arrangement position of the frame image in the first video.

In one possible implementation, the time sequence module comprises an integration network, a first conversion network, at least one self-attention network, a second conversion network and a splitting network; the integration network is configured to perform integration processing on the input data of the time sequence module to obtain an integration result, the size of the integration result is different from the size of the input data of the time sequence module, and the input data of the time sequence module includes the execution results of separate processing procedures for the multiple frame images; the first conversion network is configured to convert the integration result from a first expression to a second expression to obtain a first conversion result, the first expression is used to describe an image feature, and the second expression is used to describe a video feature; the at least one self-attention network is configured to perform self-attention processing on the first conversion result to obtain a self-attention processing result; the second conversion network is configured to convert the self-attention processing result from the second expression to the first expression to obtain a second conversion result; and the splitting network is configured to perform splitting processing on the second conversion result to obtain a splitting result, and the size of the splitting result is the same as the size of the input data of the time sequence module.

In one possible implementation, the second video is generated using a target model; the target model comprises at least one time sequence module; and the training process of the target model comprises: setting part or all parameters of at least one time sequence module in the target model to zero, and training other parts of the target model except for the at least one time sequence module according to the first image and the second image, the object described by the first image is the same object as the object described by the second image; and freezing the parameters of other parts of the target model except for the at least one time sequence module, and training the at least one time sequence module in the target model according to the first image sequence and the second image sequence, the object described by the first image sequence is the same object as the object described by the second image sequence.

In a possible implementation manner, the time sequence module includes a second conversion network; and setting part or all parameters of at least one time sequence module in the target model to zero comprises: setting a parameter of the second conversion network of at least one time sequence module in the target model to zero.

In one possible implementation, the training process of the at least one time sequence module comprises: obtaining the first image sequence, the second image sequence, and label information corresponding to at least one frame image in the second image sequence; obtaining a processed sequence by performing mask processing on at least one frame image in the first image sequence, and the processed sequence comprises the mask processing result of the at least one frame image, and for any frame image of the at least one frame image, the information described by the mask processing result of the frame image is less than the information described by the frame image; determining the prediction information corresponding to at least one frame image in the second image sequence according to the target model, the processed sequence and the body shape parameter prediction result corresponding to the at least one frame image in the second image sequence; and updating at least one time sequence module in the target model according to the prediction information corresponding to the at least one frame image in the second image sequence and the label information corresponding to the at least one frame image in the second image sequence.

In a possible implementation manner, the training process of the at least one time sequence module comprises: obtaining label noise corresponding to at least one frame image in the second image sequence; for any frame image in the second image sequence, obtaining a noise adding result corresponding to the frame image by performing noise adding processing on the frame image according to the label noise corresponding to the frame image; determining prediction information corresponding to the at least one frame image in the second image sequence according to the target model, the first image sequence, the body shape parameter prediction result corresponding to the at least one frame image in the second image sequence, and the noise adding result corresponding to the at least one frame image in the second image sequence, and the prediction information comprises predicted noise and a predicted image; determining a first loss according to the label noise corresponding to the at least one frame image in the second image sequence and the predicted noise corresponding to the at least one frame image in the second image sequence; determining a second loss according to a region segmentation result of the at least one frame image in the second image sequence, an object position detection result of the at least one frame image in the second image sequence, and a region segmentation result of the predicted image corresponding to at least one frame image in the second image sequence; and updating the at least one time sequence module in the target model according to the sum of the first loss and the second loss.

The present application provides a video generation apparatus, which comprises: a data obtaining unit, configured to obtain a first video, and at least one frame image in the first video comprises a target object; a parameter predicting unit, configured to, for any frame image in the first video, obtain a body shape parameter prediction result corresponding to the frame image by performing body shape parameter prediction processing on the frame image, the body shape parameter prediction result is used to describe the body shape of the target object in the frame image; a parameter adjusting unit, configured to, for any frame image in the first video, obtain a body shape parameter adjustment result corresponding to the frame image by performing adjustment processing on the body shape parameter prediction result corresponding to the frame image according to body shape adjustment information specified for the target object; a video generating unit, configured to generate a second video according to the first video and a body shape parameter adjustment result corresponding to the at least one frame image in the first video, the i-th frame image in the second video is used to represent a body shape adjustment parameter result for the i-th frame image in the first video, and the i-th frame image in the second video is generated according to a plurality of frame images arranged in sequence in the first video and body shape parameter adjustment results corresponding to the plurality of frame images, a distance between an arrangement position of at least one frame image of the plurality of frame images in the first video and an arrangement position of the i-th frame image in the first video is not greater than a preset distance threshold, i is a positive integer, and i is less than or equal to a number of image frames in the second video or a number of image frames in the first video.

The present application provides an electronic device, which includes: a processor and a memory; the memory is configured to store instructions or computer programs; the processor is configured to execute the instructions or computer programs in the memory, for causing the electronic device to execute the video generation method provided by the present application.

The present application provides a computer-readable medium, in which instructions or computer programs are stored. When the instructions or computer programs are run on a device, causing the device to execute the video generation method provided by the present application.

The present application provides a computer program product, which includes a computer program carried on a non-transitory computer-readable medium, and the computer program comprises program codes for executing the video generation method provided by the present application.

### BRIEF DESCRIPTION OF THE DRAWINGS

In order to more clearly illustrate the technical solutions in the embodiments of the present application or the related technologies, the drawings required for use in the embodiments or the related technical descriptions are briefly introduced below. Obviously, the drawings described below are only some embodiments recorded in the present application. For ordinary technicians in this field, other drawings can be obtained based on these drawings without paying creative work.

FIG. 1 is a flow chart of a video generation method provided in an embodiment of the present application;

FIG. 2 is a schematic diagram of a video generation process provided in an embodiment of the present application;

FIG. 3 is a schematic diagram of a diffusion model provided in an embodiment of the present application;

FIG. 4 is a schematic diagram of a time sequence module provided in an embodiment of the present application;

FIG. 5 is a schematic diagram of the structure of a video generation apparatus provided in an embodiment of the present application; and

FIG. 6 is a schematic diagram of the structure of an electronic device provided in an embodiment of the present application.

### DETAILED DESCRIPTION OF EMBODIMENTS

The present application provides a video generation method, apparatus, device, medium, and product, which are beneficial to improving the body shape adjustment effect.

Through research, it is found that for some body shape adjustment implementation schemes, these schemes can be specifically as follows: firstly perform body shape adjustment processing on the n-th frame image in the video to obtain the adjustment result corresponding to the n-th frame image, where n is a positive integer, n≤N, and N represents the number of image frames in the video; then arrange the adjustment results corresponding to these images according to the arrangement position of each frame image in the video to obtain the adjustment result corresponding to the video, so that the adjustment result corresponding to the video includes the adjustment results corresponding to these images.

After research, it was also found that the scheme shown in the previous paragraph has the following defects: because the scheme is obtained by performing body shape adjustment processing on each frame image in the video, the adjustment result corresponding to the video is prone to some sudden changes in time, such as background jumps between two adjacent frame images, large body shape changes between two adjacent frame images, and large posture changes between two adjacent frame images. As a result, the adjustment result presents poor effect in terms of temporal consistency, which in turn affects the body shape adjustment effect.

Based on the above research, in order to better improve the body shape adjustment effect, the present application provides a video generation method, which comprises: first obtaining a first video so that each frame image in the first video includes a target object; secondly, for any frame image in the first video, performing body shape parameter prediction processing on the frame image to obtain a body shape parameter prediction result corresponding to the frame image, so that the body shape parameter prediction result is used to describe the body shape of the target object in the frame image; then, for any frame image in the first video, according to the body shape adjustment information specified for the target object (such as information such as losing 20%), performing adjustment processing on the body shape parameter prediction result corresponding to the frame image to obtain the body shape parameter adjustment result corresponding to the frame image; finally, based on the first video and the body shape parameter adjustment result corresponding to each frame image in the first video, generating a second video, so that the second video is used to represent the body shape adjustment result for the first video, such as the i-th frame image in the second video is used to represent the body shape adjustment result for the i-th frame image in the first video, i is a positive integer, i≤the number of image frames in the second video or the number of image frames in the first video.

Among them, because the i-th frame image in the second video is generated based on the multiple frame images arranged in sequence in the first video and the body shape parameter adjustment results corresponding to the multiple frame images, and the distance between the arrangement position of each frame image in the multiple frame images in the first video and the arrangement position of the i-th frame image in the first video in the first video is not greater than the preset distance threshold, so that the i-th frame image in the second video can not only meet the body constraint described by the body shape parameter adjustment results corresponding to the i-th frame image in the first video, but also meet other constraints described by the multiple frame images except for the body shape, such as the time dependency of some information and other constraints, so that the second video has better time sequence consistency, which is conducive to improving the body shape adjustment effect.

It should be noted that the “time sequence consistency” involved in the present application is used to describe the natural transition state between adjacent frame images in a video, such as the natural transition of light, the natural transition of foreground state, the natural transition of a background change, the natural transition of the boundary between foreground and background, etc., so that the “time sequence consistency” can represent the time dependency of some information in time, so that the “time sequence consistency” can describe the quality of the video to a certain extent, such as high-quality videos have higher time sequence consistency, but videos with lower time sequence consistency are low-quality videos.

In addition, the present application does not limit the execution subject of the video generation method provided in the embodiment of the present application. For example, the video generation method provided in the embodiment of the present application can be applied to a terminal device or a server. For another example, the video generation method provided in the embodiment of the present application can also be implemented by means of a data interaction process between a terminal device and a server. Among them, the terminal device can be a smart phone, a computer, a personal digital assistant (PDA), a tablet computer, etc. The server can be an independent server, a cluster server or a cloud server.

In order to enable those skilled in the art to better understand the solution of the present application, the technical solution in the embodiments of the present application will be clearly and completely described below in conjunction with the drawings in the embodiments of the present application. Obviously, the described embodiments are only part of the embodiments of the present application, not all of the embodiments. Based on the embodiments in the present application, all other embodiments obtained by ordinary technicians in this field without creative work are within the scope of protection of this application.

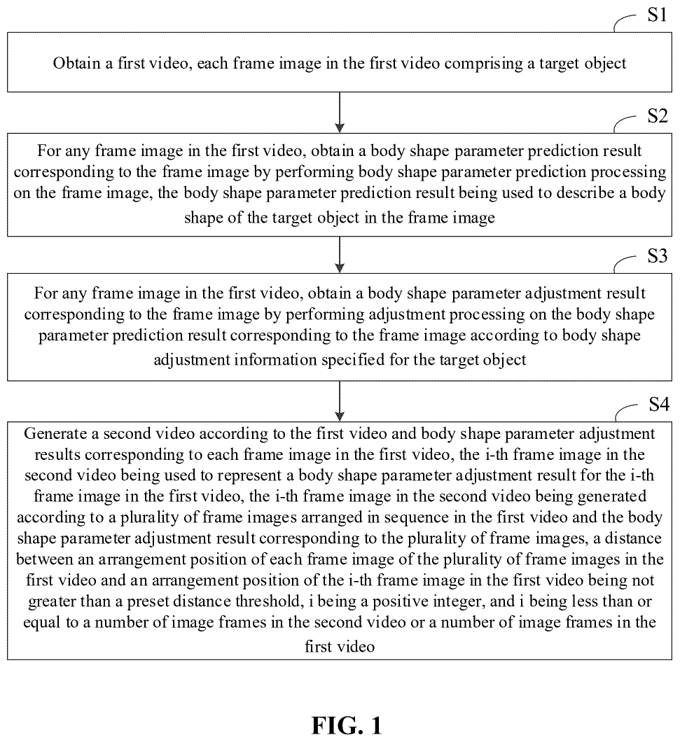

In order to better understand the technical solution provided by the present application, the video generation method provided by the present application is described below in conjunction with some drawings. As shown in FIG. 1, the video generation method provided by the embodiment of the present application includes the following S1-S4. Among them, FIG. 1 is a flow chart of a video generation method provided by the embodiment of the present application.

S1: a first video is obtained, and each frame image in the first video includes a target object.

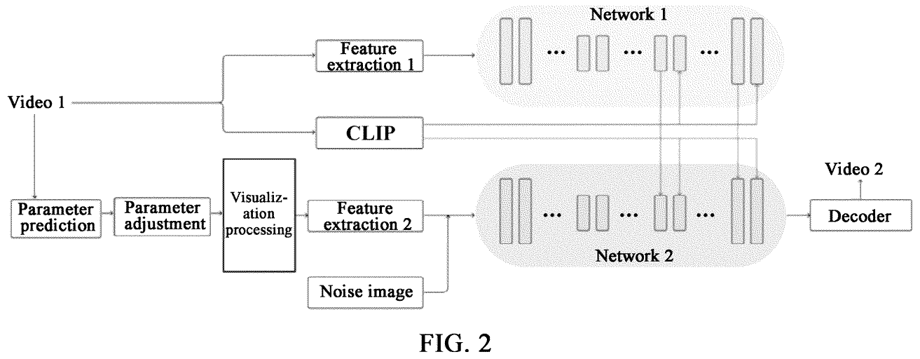

Among them, the first video refers to a video on which body shape adjustment processing needs to be performed, such as video 1 shown in FIG. 2, so that the first video can provide other information besides body shape for the subsequent video generation process, such as foreground postures, background, foreground identifications (Identity Document, ID) and other information.

It should be noted that the present application does not limit the implementation of the foreground ID in the above paragraph. For example, the foreground ID is used to describe some identifying information of the foreground presented in the first video, such as appearance, clothing, and accessories worn, so that the foreground ID can describe the identifying characteristics of the foreground presented in the first video, such as facial features. In addition, the present application does not limit the implementation of the foreground. For example, the foreground can be implemented using animals, avatars, or objects.

In addition, in some scenarios, the first video may at least meet the following constraints: the first video includes multiple frame images; and each frame image of the first video includes a target object, so that the first video can describe the state changes of the target object over time, such as posture changes, body shape changes, etc. The target object refers to the object described by the first video, such as a person, an avatar, or an animal.

In addition, the present application does not limit the above target object. For example, the target object can be used to represent the foreground described by each frame image in the first video, such as a person, a digital person, an animal, etc.; and the present application does not limit the implementation method of the target object. For example, the target object can be implemented by an animal, an avatar, or an object.

In addition, for the i-th frame image in the first video, the i-th frame image refers to the image that exists in the first video and is in the i-th arrangement position, and the i-th frame image can at least satisfy the following constraints: the i-th frame image includes the target object, so that the i-th frame image can at least describe the states of the target object at the acquisition moment corresponding to the i-th frame image, such as postures, body shapes, etc., i is a positive integer, i≤the number of image frames in the first video.

Furthermore, the present application is not limited to the implementation method of S1 above. For example, it can specifically be: receiving a video provided by a user as a first video, so that the first video can represent the video specified by the user on which body shape adjustment processing needs to be performed, so that subsequently, with the help of any implementation method of the video generation method provided by the present application, the body shape adjustment processing for the first video can be implemented to meet the video adjustment needs of the user.

S2: for any frame image in the first video, body shape parameter prediction processing is performed on the image to obtain a body shape parameter prediction result corresponding to the image, and the body shape parameter prediction result is used to describe the body shape of the target object in the image.

Among them, for the i-th frame image in the first video, the body shape parameter prediction result corresponding to the i-th frame image is obtained by performing body shape parameter prediction processing on the i-th frame image (parameter prediction as shown in FIG. 2), so that the body shape parameter prediction result can represent the body shape of the target object in the i-th frame image, i is a positive integer, i≤the number of image frames in the first video.

In addition, the present application does not limit the implementation method of the above “body shape parameter prediction result corresponding to the i-th frame image”, for example, it can be implemented using any existing or future data that can describe the body shape.

In addition, in order to better improve the accuracy, the above “body shape parameter prediction result corresponding to the i-th frame image” can meet the following constraints: the three-dimensional model with the body shape parameter prediction result is used to display the body shape of the target object in the three-dimensional space, so that the “body shape parameter prediction result corresponding to the i-th frame image” can more accurately describe the body shape of the target object in the i-th frame image.

Among them, the three-dimensional model is used to display the states of an object in three-dimensional space, such as body shapes, postures, etc.; and this application does not limit the implementation method of the three-dimensional model. For example, it can be implemented using any existing or future three-dimensional model that can change the states based on parameters.

For another example, in order to better improve the overall adjustment effect, the above three-dimensional model can be implemented using the SMPL (Skinned Multi-Person Linear) model, so that a body shape adjustment can be achieved later by adjusting some parameters of the three-dimensional model.

It should be noted that the above SMPL is a three-dimensional model construction technology; and the SMPL can describe the states of a three-dimensional object through two types of statistical parameters, namely, body shape parameter β and posture parameter θ. Among them, the body shape parameter β includes data of 10 dimensions, so that the body shape parameter β can describe the overall shape of an object through the data of the 10 dimensions, such as the body shape of the object, and the data of each dimension in the body shape parameter β can be interpreted as the states of the object as a whole under a certain shape index, such as height, fatness, etc., so that the body shape parameter β can describe the states of the object under multiple shape indexes. In addition, the posture parameter θ includes data of 24×3 dimensions, so that the posture parameter θ can describe the overall action posture of an object through the data of the 24×3 dimensions, and the 24 in the “24×3” refers to 23 joint points+1 root node, and the 3 in the “24×3” refers to the value in the axis angle.

Based on the above four paragraphs, it can be known that in a possible implementation manner, the above “body shape parameter prediction result corresponding to the i-th frame image” may include the body shape parameter in the SMPL parameters predicted for the i-th frame image, so that the “body shape parameter prediction result corresponding to the i-th frame image” can describe the body shape state of the target object in the i-th frame image in the three-dimensional space, thereby enabling the “body shape parameter prediction result corresponding to the i-th frame image” to more accurately describe the body shape of the target object presented in the i-th frame image.

It should be noted that the present application is not limited to the above-mentioned SMPL parameters prediction method. For example, it can adopt any existing or future method that can perform SMPL parameter prediction processing on a two-dimensional image, such as a pre-built machine learning model with SMPL parameter prediction function.

In addition, the present application does not limit the implementation of S2 above. For example, S2 can be implemented by adopting any existing or future method that can perform body shape parameter prediction processing on an image, such as a method implemented by means of a pre-built machine learning model with body shape parameter prediction function. For another example, in order to better improve the overall adjustment effect, S2 can be implemented by SMPL technology.

It can be seen that, in a possible implementation manner, the above S2 can specifically be: firstly performing SMPL parameter prediction processing on the i-th frame image in the first video (parameter prediction processing as shown in FIG. 2) to obtain a state parameter prediction result corresponding to the i-th frame image, so that the state parameter prediction result is used to describe the states of the target object in the i-th frame image (states such as body shape and posture), and the state parameter prediction result to include body shape parameter β and posture parameter θ; then, based on the state parameter prediction result, determining the body shape parameter prediction result corresponding to the i-th frame image, so that the body shape parameter prediction result includes the body shape parameter β, and the three-dimensional model with the body shape parameter prediction result belongs to the SMPL model, so that the three-dimensional model with the body shape parameter prediction result can better display the body shape of the target object in the i-th frame image in three-dimensional space, i is a positive integer, i≤the number of image frames in the first video.

It should be noted that the present application does not limit the implementation method of the SMPL prediction processing in the above paragraph. For example, it can adopt any existing or future method that can predict the SMPL parameters of an image, such as by means of a pre-built machine learning model with SMPL parameter prediction function.

Based on the relevant content of S2 above, it can be known that in some scenarios, such as video shooting scenarios, video beautification scenarios or video modification scenarios, after obtaining the first video provided by the user, the body shape parameter prediction processing can be performed on each frame image in the first video to obtain the body shape parameter prediction result corresponding to each frame image, so that the body shape parameter prediction result corresponding to each frame image can respectively describe the body shape of the target object in the corresponding image, so that the body shape parameter prediction results corresponding to these images can describe the body shape presented by the target object in the first video.

S3: for any frame image in the first video, according to the body shape adjustment information specified for the target object, adjustment processing on the predicted body shape parameter result corresponding to the image is performed to obtain the body shape parameter adjustment result corresponding to the image.

Among them, the body shape adjustment information is used to describe the body shape adjustment requirements specified by the user for the target object in the first video, such as the requirement of becoming 0.5 times thinner overall, so that the body shape adjustment information can represent the body shape adjustment requirements for each frame image in the first video.

In addition, the present application does not limit the implementation method of the body shape adjustment information, for example, the body shape adjustment information may include an adjustment strength value. The adjustment strength value may belong to any value in the range of [−1, 1], so that the adjustment strength value can indicate the degree of making an object fat or thin as a whole. For example, if the adjustment strength value is −0.5, the adjustment strength value can indicate that the object is thinner by 0.5 times as a whole; if the adjustment strength value is 0.5, the adjustment strength value can indicate that the object is fatter by 0.5 times as a whole.

In addition, the present application does not limit the method for obtaining the body shape adjustment information. For example, the body shape adjustment information can be obtained based on the content input by the user through the interactive interface, such as the adjustment strength value of −0.5.

For the i-th frame image in the first video, the body shape parameter adjustment result corresponding to the i-th frame image is obtained by performing adjustment processing on the body shape parameter prediction result corresponding to the i-th frame image according to the above body shape adjustment information, so that the difference between the body shape described by the body shape parameter adjustment result and the body shape described by the body shape parameter prediction result is consistent with the difference described by the body shape adjustment information, so that the difference between the body shape described by the body shape parameter adjustment result and the body shape described by the body shape parameter prediction result meets the body shape adjustment requirement described by the body shape adjustment information, i is a positive integer, i≤the number of image frames in the first video.

In addition, the present application does not limit the implementation method of S3 above. For example, it can be implemented by adopting any existing or future parameter adjustment method, such as a method for adjusting SMPL parameters.

For example, in some scenarios, S3 above can be specifically as follows: first, based on the above body shape adjustment information, determining the offset of the body shape parameter prediction result corresponding to each frame image in the first video; then, based on the offset of the body shape parameter prediction result corresponding to each frame image, performing adjustment processing on the body shape parameter prediction result corresponding to each frame image respectively to obtain the body shape parameter adjustment result corresponding to each frame image.

Among them, for the i-th frame image in the first video, the offset of the body shape parameter prediction result corresponding to the i-th frame image is used to describe: the difference between the body shape parameter prediction result corresponding to the i-th frame image and the body shape parameter expected by the above body shape adjustment information, so that the body shape parameter prediction result corresponding to the i-th frame image can be adjusted according to the offset to obtain the body shape parameter expected by the body shape adjustment information.

It should be noted that, for the “body shape parameter expected by the body shape adjustment information” in the previous paragraph, the “body shape parameter expected by the body shape adjustment information” refers to the parameter that can meet the state adjustment requirements described by the body shape adjustment information, such as the body shape parameter adjustment result corresponding to the i-th frame image.

In addition, the present application does not limit the implementation method of the above offset. For example, when the body shape parameter prediction result corresponding to the i-th frame image above includes data of multiple dimensions, the offset of the body shape parameter prediction result corresponding to the i-th frame image includes the offset of each dimension, so that the data of the corresponding dimension can be subsequently corrected respectively, based on the offset of each dimension to obtain the adjustment result of the data of the corresponding dimension.

It can be seen that in a possible implementation, when the body shape parameter prediction result corresponding to the i-th frame image above includes data of M dimensions, such as data of 10 dimensions, the offset of the body shape parameter prediction result corresponding to the i-th frame image may include the offset of the first dimension, the offset of the second dimension, . . . , and the offset of the M-th dimension, so that the process of determining the body shape parameter adjustment result corresponding to the i-th frame image may comprise: firstly adjusting the data of the m-th dimension according to the offset of the m-th dimension to obtain the adjustment result of the m-th dimension, such as the adjustment result of the m-th dimension=the data of the m-th dimension+the offset of the m-th dimension, m is a positive integer, m≤M, M is a positive integer; then, according to the adjustment result of the first dimension, the adjustment result of the second dimension, . . . , and the adjustment result of the M-th dimension, determining the body shape parameter adjustment result corresponding to the i-th frame image, so that the body shape parameter adjustment result includes the adjustment results of these dimensions. Among them, i is a positive integer, i≤the number of image frames in the first video.

In addition, the present application does not limit the method for determining the above offset. For example, it can be specifically: according to a pre-set rule, mapping the above body shape adjustment information to the offset of the body shape parameter. For another example, it can be specifically: first searching for an offset that has a corresponding relationship with the above body shape adjustment information from a pre-constructed mapping relationship, and using it as the offset of the body shape parameter prediction result corresponding to each frame image in the first video. Among them, the mapping relationship is used to record different body shape adjustment information, such as the offset corresponding to different adjustment strength values, so that the offset corresponding to the body shape adjustment information specified by the user can be quickly obtained later with the help of the mapping relationship.

Based on the relevant content of S3 above, it can be known that in some scenarios, for the i-th frame image in the first video, after obtaining the body shape parameter prediction result corresponding to the i-th frame image, such as the 10-dimensional body shape parameter, the offset of the body shape parameter prediction result can be determined according to the body shape adjustment information specified by the user for the target object, such as the 10-dimensional offset, so that the offset can indicate how to adjust the body shape parameter prediction result to meet the adjustment requirements described by the body shape adjustment information; and then the body shape parameter prediction result is adjusted according to the offset to obtain the body shape parameter adjustment result corresponding to the i-th frame image, so that the body shape parameter adjustment result meets the body shape adjustment requirements specified by the user for the target object, i is a positive integer, and i≤the number of image frames in the first video.

S4: a second video is generated based on the first video and the body shape parameter adjustment result corresponding to each frame image in the first video, the i-th frame image in the second video is used to represent the body shape adjustment result for the i-th frame image in the first video, and the i-th frame image in the second video is generated based on multiple frame images arranged in sequence in the first video and the body shape parameter adjustment results corresponding to the multiple frame images, and the distance between the arrangement position of each frame image in the multiple frame images in the first video and the arrangement position of the i-th frame image in the first video is not greater than a preset distance threshold, i is a positive integer, and i≤the number of image frames in the second video or the number of image frames in the first video.

Among them, the second video is used to represent the body shape adjustment result of the first video according to the above body shape adjustment information, such as video 2 shown in FIG. 2, so that the second video and the first video can at least meet the following constraints: the second video and the first video are in a time-aligned state, and the body shape described by the second video is different from the body shape described by the first video.

It can be seen that, in one possible implementation, the second video above can at least satisfy the following constraints: the i-th frame image in the second video is used to represent the body shape adjustment result for the i-th frame image in the first video, so that the difference between the body shape described by the i-th frame image in the second video and the body shape described by the i-th frame image in the first video can satisfy the difference described by the above body shape adjustment information as much as possible, i is a positive integer, i≤the number of image frames in the second video.

In addition, in a possible implementation, in order to better improve the effect, the second video above can at least satisfy the following constraints: the i-th frame image in the second video is used to represent the body shape adjustment result for the i-th frame image in the first video, the body shape described by the i-th frame image in the second video is different from the body shape described by the i-th frame image in the first video, and the other information except for the body shape described by the i-th frame image in the second video is consistent with the other information except for the body shape described by the i-th frame image in the first video, i is a positive integer, i≤the number of image frames in the second video, so that the interference caused by the body shape modification to other image information can be effectively reduced, thereby helping to improve the effect.

In addition, in a possible implementation, in order to better improve the effect, the second video above can at least meet the following constraints: the body shape parameter prediction result corresponding to each frame image in the second video remains consistent, so as to ensure that the objects described by different images in the second video are as consistent as possible in body shape, thereby helping to avoid adverse effects caused by large differences between the body shapes of objects described by different images in the generated video, such as poor visual effects, and thus helping to improve the body shape modification effect.

It should be noted that the present application does not limit the implementation method of the concept of “remaining consistent”. For example, in some scenarios, the concept of “remaining consistent” is used to indicate being completely identical. As an example, if information 1 is consistent with information 2, it can indicate that information 1 is completely identical with information 2.

For example, in some scenarios, the concept of “remaining consistent” is used to indicate a high degree of similarity. For example, if information 1 is consistent with information 2, it can indicate that the similarity between information 1 and information 2 is high, such as the similarity between information 1 and information 2 is higher than a preset similarity threshold.

In addition, in order to better ensure the time sequence consistency, the second video above can at least meet the following constraints: the i-th frame image in the second video is used to represent the body shape adjustment result for the i-th frame image in the first video, the i-th frame image in the second video is generated based on the multiple frame images arranged in sequence in the first video and the body shape parameter adjustment results corresponding to the multiple frame images, and the distance between the arrangement position of each frame image in the multiple frame images in the first video and the arrangement position of the i-th frame image in the first video in the first video is not greater than the preset distance threshold, i is a positive integer, i≤the number of image frames in the second video. The preset distance threshold can be set according to the actual application scenario.

It can be seen that when the above preset distance threshold is Y, and Y is a positive integer, if the i-th frame image in the second video is used to represent the body shape adjustment result for the ith frame image in the first video, then the i-th frame image in the second video can be generated based on the i-Y-th frame image in the first video and the body shape parameter adjustment result corresponding to the i-Y-th frame image, the i−Y+1-th frame image in the first video and the body shape parameter adjustment result corresponding to the i−Y+1-th frame image, . . . (and so on), and the i+Y-th frame image in the first video and the body shape parameter adjustment result corresponding to the i+Y-th frame image, so that the generation process of the i-th frame image in the second video not only refers to the relevant information of the i-th frame image in the first video, but also refers to the relevant information of some neighboring images of the i-th frame image in the first video, so that the i-th frame image in the second video and some neighboring images of the i-th frame image in the second video present relatively good time sequence characteristics, such as change trend, time dependence, etc., i is a positive integer, i≤the number of image frames in the second video, so that the finally generated second video has better time sequence consistency.

In addition, in some scenarios, in order to better improve the time sequence consistency, the second video above can at least meet the following constraints: the i-th frame image in the second video is used to represent the body shape adjustment result for the i-th frame image in the first video, and the i-th frame image in the second video is generated based on all the images in the first video and the body shape parameter adjustment results corresponding to all the images, so that the generation process of the i-th frame image in the second video not only refers to the relevant information of the i-th frame image in the first video, but also refers to the relevant information of other images in the first video, so that the i-th frame image in the second video and other images in the second video present better time sequence characteristics, such as change trend, time dependence, etc., which is conducive to improving the body shape adjustment effect.

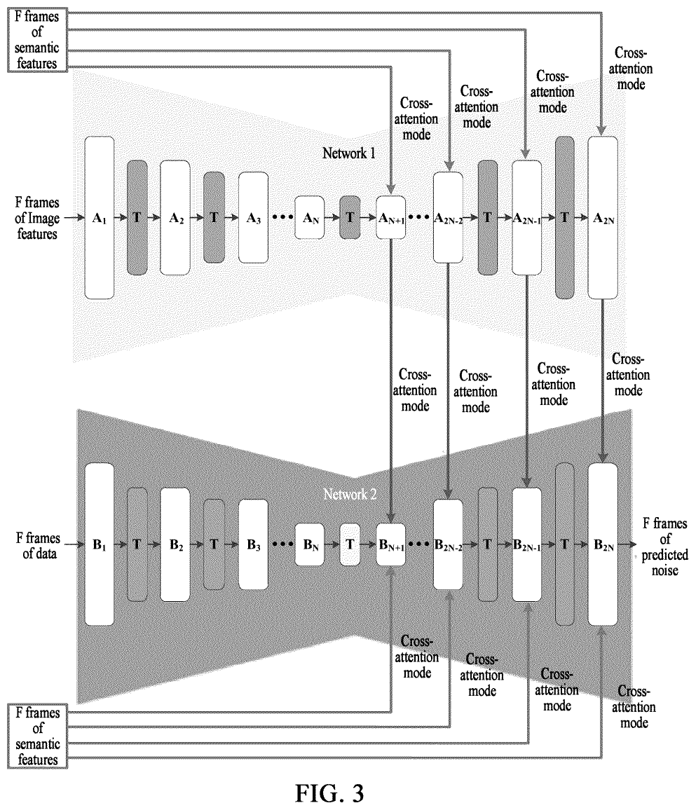

In addition, the present application does not limit the implementation of S4 above. For example, S4 can be implemented with the help of a target model. The target model is used to generate a new video based on the input data of the target model; and the present application does not limit the target model. For example, the target model can be implemented using any existing or future diffusion model. It can be seen that in one possible implementation, the target model can include at least one UNet network, such as the two UNet networks shown in FIG. 2 or FIG. 3.

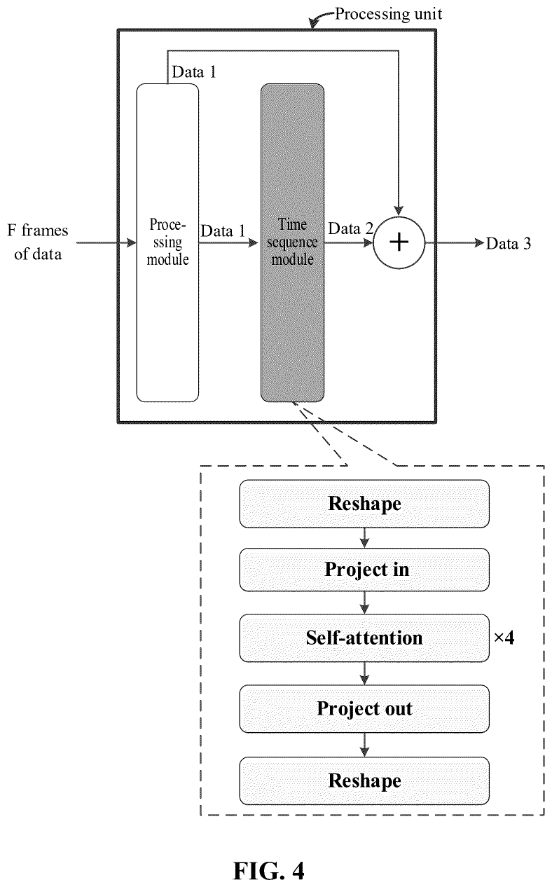

In addition, in order to better improve the body shape adjustment effect, the present application also provides a possible implementation of the above-mentioned target model. For example, the target model can at least satisfy the following constraints: the target model includes at least one processing unit (the processing unit shown in FIG. 4), and the processing unit includes an image-level processing module and a time sequence module. The image-level processing module is configured to separately implement a separate processing procedure for each frame image of the above-mentioned multiple frame images, and the time sequence module is configured to perform attention processing on the execution results of the separate processing procedures for the multiple frame images in the time direction.

The processing unit refers to a unit existing in the target model and used to process multiple images, such as the processing unit shown in FIG. 4 or a unit including the B₁ module and the T module shown in FIG. 3.

It should be noted that, for network 2 in FIG. 3, the B₁ module is configured to implement down-sampling processing of the first size, and the size of the output data of the B₁ module is the first size; the B₂ module is configured to implement down-sampling processing of the second size, and the size of the output data of the B₂ module is the second size; . . . (and so on); the Bx module is configured to implement down-sampling processing of the N-th size, and the size of the output data of the By module is the N-th size; the B_{N+1} module is configured to implement up-sampling processing of the N-th size, and the size of the input data of the B_{N+1} module is the N-th size; the B_{N+2} module is configured to implement up-sampling processing of the N−1-th size, and the size of the input data of the B_{N+2} module is the N−1-th size; . . . (and so on); the B_{2N} module is configured to implement up-sampling processing of the first size, and the size of the input data of the B_{2N} module is the first size; the T module represents a temporal module. In addition, for network 1 in FIG. 3, the A₁ module is configured to implement down-sampling processing of the first size, and the size of the output data of the A₁ module is the first size; the A₂ module is configured to implement down-sampling processing of the second size, and the size of the output data of the A₂ module is the second size; . . . (and so on); the A_{N} module is configured to implement down-sampling processing of the N-th size, and the size of the output data of the A_{N} module is the N-th size; the A_{N+1} module is configured to implement up-sampling processing of the N-th size, and the size of the input data of the A_{N+1} module is the N-th size; the A_{N+2} module is configured to implement up-sampling processing of the N−1-th size, and the size of the input data of the A_{N+2} module is the N−1-th size; . . . (and so on); the A_{2N} module is configured to implement up-sampling processing of the first size, and the size of the input data of the A_{2N} module is the first size; the T module represents a temporal module (Temporal Module).

In addition, the above processing unit can at least meet the following constraints: the processing unit comprises an image-level processing module (a processing module as shown in FIG. 4, any one of B₁-B_{2N} shown in FIG. 3, or any one of A₁-A_{2N} shown in FIG. 3) and a time sequence module (a time sequence module as shown in FIG. 4 or a T module as shown in FIG. 3), so that the processing unit can not only implement some separate processing procedures for each frame image in the first video, but also implement some joint processing procedures for multiple frame images in the first video, so that the processing unit presents a better effect in terms of time sequence consistency.

For the above-mentioned image-level processing module, such as the processing module shown in FIG. 4, the image-level processing module refers to a module existing in the above-mentioned processing unit for realizing image-level related processing, so that the image-level processing module can perform processing in units of images, so that the image-level processing module can be configured to realize image-level processing for the input data of the image-level processing module (F frames data as shown in FIG. 4), and then when the image-level processing module is used to realize related processing for multiple frame images in the first video, the image-level processing module can realize related processing for each frame image of the image separately in a parallel or serial manner to ensure that the related processing of different images are independent of each other and do not interfere with each other.

In addition, the present application does not limit the implementation method of the above image-level processing module. For example, when the above target model is implemented with the help of a diffusion model, if the target model includes at least one UNet network, the image-level processing module can be implemented using each up-sampling module and each down-sampling module in the UNet network.

For the above time sequence module, such as the time sequence module shown in FIG. 4, the time sequence module refers to a module existing in the above processing unit for implementing related processing at the video level (or sequence level), so that the time sequence module can be processed in units of image sequences, so that the time sequence module can be used to implement video-level processing procedures for the input data of the time sequence module or the output data of the image-level processing module in the processing unit (data 1 as shown in FIG. 4), and then when the time sequence module is configured to implement related processing for multiple frame images in the first video (such as F frame images), the time sequence module can process the multiple frame images as a whole to ensure that the related processing of each frame image of the multiple frames not only refers to the image itself, but also needs to refer to other images, which is conducive to better achieving time sequence consistency.

In addition, the present application does not limit the implementation method of the above time sequence module. For example, it can be implemented using any neural network that can achieve time sequence consistency optimization processing.

In addition, in order to better improve the effect, the above time sequence module may include an integration network, a first conversion network, at least one self-attention network, a second conversion network and a splitting network, so that the time sequence module has better time sequence consistency optimization performance. For ease of understanding, each network is introduced below.

For the integration network in the time sequence module above, the integration network is configured to perform integration processing on the input data of the time sequence module (or, the output data of the image-level processing module in the processing unit of the time sequence module) to obtain an integration result, so that the size of the integration result is different from the size of the input data of the time sequence module, and the integration result can represent the subsequent processing of the input data of the time sequence module as a whole. Among them, the input data of the time sequence module refers to the data input by the time sequence module including the integration network, such as data 1 shown in FIG. 4. For ease of understanding, the following is an explanation with examples.

As an example, for a time sequence module, when the size of the input data of the time sequence module is [b, c, F, h, w], b represents the number of batches, c represents the number of channels, F represents the number of image frames, h represents the image height, and w represents the image width, the integration network in the time sequence module is configured to perform integration processing on the input data of the time sequence module to obtain an integration result, so that the size of the integration result is [b×h×w, F, c], so that the integration result can indicate the subsequent processing of the input data of the time sequence module as a whole.

In addition, the present application is not limited to the above integration network, for example, it can be implemented by using Reshape, such as the Reshape shown in FIG. 4.

For the first conversion network in the above time sequence module, such as the Project in module shown in FIG. 4, the first conversion network is configured to perform expression conversion processing on the output data of the integration network in the time sequence module, and the expression conversion processing can be specifically: when the output data of the integration network is the above integration result, the first conversion network is configured to convert the integration result from the first expression to the second expression to obtain the first conversion result, so that the first conversion result can describe the information described by the integration result according to the expression possessed by the video feature, so that the first conversion result can not only express the information described by the integration result, but also express the unique characteristics of the video feature, and then the self-attention processing achieved based on the first conversion result can better capture the unique characteristics of the video feature, which is conducive to improving the video generation effect. Among them, the first expression is used to describe the image feature, so that the first expression is the expression possessed by the image feature, so that the first expression can express the unique characteristics of the image feature. The second expression is used to describe the video feature, so that the second expression is an expression possessed by the video feature, thereby enabling the second expression to express the unique characteristics of the video feature.

In addition, the present application does not limit the implementation method of the first conversion network mentioned above. For example, the first conversion network can be implemented by full connection.

For at least one self-attention network in the above time sequence module, such as Self-attention×4 as shown in FIG. 4, these self-attention networks are used to perform self-attention processing on the output data of the first conversion network above, so that these self-attention networks can realize the above “performing attention processing in the time direction”, so that these self-attention networks can capture the time dependency between features at the same position on the time axis from the output data, and then make the data obtained based on the time dependency (such as the self-attention processing result below) have better time sequence consistency.

It can be seen that when the output data of the first conversion network in the above time sequence module is the first conversion result, at least one self-attention network in the time sequence module can be configured to: perform self-attention processing on the first conversion result to obtain a self-attention processing result so that the self-attention processing result presents better time sequence consistency.

In addition, the present application does not limit the working principle of the at least one self-attention network above. For example, when the at least one self-attention network includes D self-attention networks, and D is a positive integer, the working principle of the at least one self-attention network can be specifically as follows: the first self-attention network performs self-attention processing on the output data of the first conversion network above to obtain the output data of the first self-attention network; the second self-attention network performs self-attention processing on the output data of the first self-attention network to obtain the output data of the second self-attention network; the third self-attention network performs self-attention processing on the output data of the second self-attention network to obtain the output data of the third self-attention network; . . . (and so on); the D-th self-attention network performs self-attention processing on the output data of the D−1-th self-attention network to obtain the output data of the D-th self-attention network, and the output data of the D-th self-attention network is regarded as the output data of the at least one self-attention network (such as the self-attention processing result above) for subsequent processing.

In addition, the present application does not limit the implementation method of the above self-attention network. For example, the self-attention network can be implemented using any existing or future self-attention network.

For the second conversion network in the above time sequence module, such as the Project out module shown in FIG. 4, the second conversion network is configured to perform inverse conversion of expression processing on the output data of at least one self-attention network in the time sequence module, and the inverse conversion of the expression processing can be specifically: when the output data of the at least one self-attention network is the above self-attention processing result, the second conversion network is configured to convert the self-attention processing result from the second expression to the first expression to obtain a second conversion result, so that the second conversion result can describe the information described by the self-attention processing result according to the expression possessed by the image feature.

In addition, the present application does not limit the implementation method of the second conversion network mentioned above. For example, the second conversion network can be implemented by full connection.

For the splitting network in the above time sequence module, the splitting network is configured to perform splitting processing on the output data of the second conversion network in the time sequence module, and the splitting processing can be specifically: when the output data of the second conversion network is the second conversion result above, the splitting network is configured to perform splitting processing on the second conversion result to obtain a splitting result, such as data 2 shown in FIG. 4, so that the size of the splitting result is the same as the size of the input data of the time sequence module, so that the size of the splitting result can be [b, c, F, h, w].

In addition, the application is not limited to the above split network, for example, it can be implemented by using Reshape, such as the Reshape shown in FIG. 4.

Based on the relevant content of the time sequence module above, it can be known that in a possible implementation mode, when the size of the input data of the time sequence module is [b, c, F, h, w], the working principle of the time sequence module can be: firstly, reshaping the input data of the time sequence module to the size of [b×h×w, F, c] to obtain an integration result; then converting the integration result from the image feature expression to the video feature expression through a full connection method to obtain a first conversion result, so that the size of the first conversion result remains unchanged; then, processing the first conversion result through multiple self-attention networks (such as 4 self-attention networks) to obtain a self-attention processing result, so that the self-attention processing result can at least express the time dependency between the features at the same position on the time axis captured by means of these self-attention networks; secondly, converting the self-attention processing result from a video feature expression to an image feature expression through a full connection method to obtain a second conversion result; finally, reshaping the second conversion result to the size of [b, c, F, h, w] to obtain the output data of the time sequence module (such as the splitting result above), so that the time sequence consistency optimization processing can be achieved for multiple frame images.

In addition, in some scenarios, in order to better improve the time sequence consistency optimization effect, the present application also provides a possible implementation method of the above-mentioned time sequence module. In this method, when the processing unit includes an image-level processing module and the time sequence module, and the image-level processing module is configured to separately implement a separate processing procedure for each frame image in the multiple frame images in the first video above, the time sequence module can at least meet the following constraints: the time sequence module is configured to perform attention processing on the execution results of the separate processing procedures for the multiple frame images in the time direction, and the attention processing is also implemented based on the time information of each frame image in the multiple frame images; wherein, for any frame image in the multiple frame images, the time information of the image is used to describe the arrangement position of the image in the first video.

For the i-th frame image in the first video, the time information of the i-th frame image is used to describe the arrangement position of the i-th frame image in the first video (or the acquisition time corresponding to the i-th frame image in the first video); and the present application does not limit the implementation method of the time information. For example, it can be implemented using the arrangement position to ensure that the time information involved in the reasoning process and the time information involved in the training process remain consistent, which is beneficial to improving the body shape adjustment effect.

For another example, in order to better improve the effect, the time information of the i-th frame image above can be obtained by performing position coding processing (such as sinusoidal position coding processing) on the arrangement position of the i-th frame image in the first video, so that the time information can better represent the spatiotemporal position of the i-th frame image in the first video.

It can be seen that in one possible implementation, the time information of the i-th frame image in the first video may include the position encoding result of the arrangement position of the i-th frame image in the first video, so that the time information can better describe the spatiotemporal position of the i-th frame image in the first video.

In addition, the present application does not limit the usage of the above-mentioned time information by the time sequence module. For example, when the above-mentioned “multiple frame images arranged in sequence in the first video” include all images in the first video, the above-mentioned processing unit includes an image-level processing module and the time sequence module, and the image-level processing module is configured to separately implement a separate processing procedure for each frame image of the multiple frame images, the execution result of the separate processing procedure of the i-th frame image in the first video can be first fused with the time information of the i-th frame image, such as splicing, to obtain the fusion result of the i-th frame image, where i is a positive integer, i≤the number of image frames in the first video; and then the fusion result of the multiple frame images is input into the time sequence module, so that the time sequence module performs time sequence consistency optimization processing on these fusion results.

Based on the relevant content of the processing unit above, it can be known that in a possible implementation, the target model above can at least meet the following constraints: the target model includes at least one image-level processing module and a time sequence module corresponding to each image-level processing module, and for any image-level processing module in the at least one image-level processing module, the input data of the time sequence module corresponding to the image-level processing module includes the output data of the image-level processing module. For ease of understanding, two examples are used for explanation below.

Example 1. In some scenarios, the target model above may include an image-level processing module and a time sequence module; and the working principle of the target model may be: that the image-level processing module first processes the input data of the target model to obtain the output data of the image-level processing module; then, the time sequence module processes the output data of the image-level processing module to obtain the output data of the time sequence module; then, based on the output data of the time sequence module, the output data of the target model is determined, as shown in the second video above.

It should be noted that the present application does not limit the implementation method of the image-level processing module in the above paragraph. For example, when the above target model is implemented with the help of at least one UNet network, the image-level processing module may include at least one UNet network. Among them, the UNet network can be implemented using any existing or future UNet network that can implement image-level processing.

Example 2. In some scenarios, the above target model may include Q image-level processing modules and Q time sequence modules; and the working principle of the target model may be: that first, the first image-level processing module processes the input data of the target model to obtain the output data of the first image-level processing module; then, the first time sequence module processes the output data of the first image-level processing module to obtain the output data of the first time sequence module; then, the second image-level processing module processes the output data of the first time sequence module to obtain the output data of the second image-level processing module; then, the second time sequence module processes the output data of the second image-level processing module to obtain the output data of the second time sequence module; then, the third image-level processing module processes the output data of the second time sequence module to obtain the output data of the third image-level processing module; then, the third time sequence module processes the output data of the third image-level processing module to obtain the output data of the third time sequence module; . . . (and so on); then, the Q−1-th image-level processing module processes the output data of the Q−1-th time sequence module to obtain the output data of the Q-th image-level processing module; then, the Q-th time sequence module processes the output data of the Q-th image-level processing module to obtain the output data of the Q-th time sequence module. Among them, Q is a positive integer.

It should be noted that the present application does not limit the implementation method of the qth image-level processing module in the above paragraph. For example, when the above target model is implemented with the help of a UNet network, the qth image-level processing module may refer to a module existing in the UNet network and located in the qth arrangement position, such as an up-sampling module or a down-sampling module, etc., q is a positive integer, q≤Q, and Q is a positive integer.

It can be seen that, in one possible implementation, the above target model can at least satisfy the following constraints: the target model includes at least one processing unit, and the at least one processing unit includes multiple up-sampling modules, a time sequence module corresponding to each up-sampling module, multiple down-sampling modules, and a time sequence module corresponding to each down-sampling module; wherein, for any up-sampling module, the time sequence module corresponding to the up-sampling module is configured to perform attention processing on the output data of the up-sampling module in the time direction; for any down-sampling module, the time sequence module corresponding to the down-sampling module is configured to perform attention processing on the output data of the down-sampling module in the time direction, so that time sequence consistency optimization processing can be achieved at as many resolutions as possible, which is beneficial to expand the receptive field, and then to better achieve time sequence consistency.

In addition, the present application does not limit the implementation method of the target model shown in the previous paragraph. For ease of understanding, two examples are used for explanation below.

Example 1, in some scenarios, if the above target model is implemented with the aid of a single UNet network, the target model may include a plurality of modules in a sequential arrangement state, and the plurality of modules include a down-sampling module of the first size (such as the B₁ module shown in FIG. 4), a time sequence module corresponding to the down-sampling module of the first size, a down-sampling module of the second size (such as the B₂ module shown in FIG. 4), a time sequence module corresponding to the down-sampling module of the second size, . . . , a down-sampling module of the N-th size (such as the Bx module shown in FIG. 4), a time sequence module corresponding to the down-sampling module of the N-th size, an up-sampling module of the N-th size (such as the B_{N+1} module shown in FIG. 4), a time sequence module corresponding to the up-sampling module of the N-th size, an up-sampling module of the N−1-th size, a time sequence module corresponding to the up-sampling module of the N−1-th size, . . . , an up-sampling module of the second size (such as the B_{2N-1} module shown in FIG. 4), a time sequence module corresponding to the up-sampling module of the second size, and an up-sampling module of the first size (such as the B_{2N} module shown in FIG. 4).

For the down-sampling module of the n-th size mentioned above, the down-sampling module of the n-th size can be used to implement down-sampling processing of the n-th size; the size of the output data of the down-sampling module of the n-th size is the n-th size; and the time sequence module corresponding to the down-sampling module of the n-th size is configured to perform time sequence consistency optimization processing on the resolution described by the n-th size for the output data of the down-sampling module of the n-th size, where n is a positive integer, n≤N.

In addition, the present application does not limit the implementation method of the input data of the down-sampling module of the n-th size mentioned above. For example, when n=1, the input data of the down-sampling module of the n-th size may include the input data of the target model; when n≥2, the input data of the down-sampling module of the n-th size may include the output data of the time sequence module corresponding to the down-sampling module of the n−1-th size.

In addition, in some scenarios, such as scenarios with relatively high requirements for model training effects, when n≥2, the input data of the down-sampling module of the n-th size described above may include the sum or residual between the output data of the time sequence module corresponding to the down-sampling module of the n−1-th size described above and the output data of the down-sampling module of the n−1-th size, such as data 3 shown in FIG. 4.

The up-sampling module of the n-th size mentioned above is configured to implement up-sampling processing of the n-th size; the size of the input data of the up-sampling module of the n-th size is the n-th size; and the time sequence module corresponding to the up-sampling module of the n-th size is configured to perform time sequence consistency optimization processing on the resolution described by the n−1-th size for the output data of the up-sampling module of the n-th size, where n is a positive integer, n≤N.

In addition, the present application does not limit the implementation method of the input data of the up-sampling module of the n-th size above. For example, when n=N, the input data of the up-sampling module of the n-th size may include the output data of the time sequence module corresponding to the down-sampling module of the n-th size above; when n≤N−1, the input data of the up-sampling module of the n-th size may include the output data of the time sequence module corresponding to the up-sampling module of the n+1-th size.

In addition, in some scenarios, such as scenarios with relatively high requirements for model training effects, when n=N, the input data of the up-sampling module of the n-th size above may include the sum or residual of the output data of the time sequence module corresponding to the down-sampling module of the N-th size above and the output data of the down-sampling module of the N-th size; when n≤N−1, the input data of the up-sampling module of the n-th size may include the sum or residual of the output data of the time sequence module corresponding to the up-sampling module of the n+1-th size and the output data of the up-sampling module of the n+1-th size.

Example 2, in some scenarios, if the above target model is implemented with the help of two UNet networks, the target model can at least meet the following constraints: the target model includes a first network (network 1 as shown in FIG. 3) and a second network (network 2 as shown in FIG. 3); the network structure of the first network is the same as the network structure of the second network; the first network includes a plurality of first modules in a sequential arrangement state, and the second network includes a plurality of second modules in a sequential arrangement state; the output data of part or all modules in the first network are injected into the corresponding modules in the second network through a cross-attention method; the input data of the first network is determined based on the first video; the input data of the second network is determined based on the body shape parameter adjustment result corresponding to each frame image in the first video.

It should be noted that the implementation method of the “a plurality of first modules in a sequential arrangement state” in the upper paragraph is similar to the implementation method of the “a plurality of modules in a sequential arrangement state” above, and the implementation method of the “a plurality of second modules in a sequential arrangement state” in the upper paragraph is also similar to the implementation method of the “a plurality of modules in a sequential arrangement state” above. For the sake of brevity, they will not be repeated here.

In addition, the present application does not limit the working principle of the first network above. For example, when the input data of the first network is determined based on the first video, the working principle of the first network (the working principle of network 1 as shown in FIG. 2) may include: after obtaining the image features of the i-th frame image in the first video, the first network performs processing on the image features to obtain the output data of each module in the first network; and the semantic features of the i-th frame image in the first video are introduced into part or all modules (such as at least one up-sampling module) in the first network through cross-attention method, so that these part or all modules can perform corresponding processing based on the semantic features.

For the i-th frame image in the first video above, the image feature of the i-th frame image is obtained by performing image feature extraction processing on the i-th frame image, such as feature extraction 1 shown in FIG. 2, so that the image feature of the i-th frame image is used to describe the information carried by the i-th frame image, such as local information of each pixel and some global information of the i-th frame image; the semantic feature of the i-th frame image is obtained by performing semantic feature extraction processing on the i-th frame image, such as the contrastive language-image pre-training (CLIP) model shown in FIG. 2, so that the semantic feature of the i-th frame image is used to describe the semantic information carried by the i-th frame image, such as information similar to image architecture, etc., i is a positive integer, i≤the number of image frames in the first video.

It should be noted that the present application does not limit the implementation method of the “image feature extraction processing” in the previous paragraph. For example, it can be implemented by using any existing or future encoder that has the function of performing image feature extraction on images. In addition, the present application does not limit the implementation method of the “semantic feature extraction processing” in the previous paragraph. For example, it can be implemented by using any existing or future encoder that has the function of performing image feature extraction on images, such as the image encoder in the CLIP model.

In addition, the present application does not limit the working principle of the second network mentioned above. For example, when the second network is used to implement denoising processing, and the input data of the second network is determined based on the body shape parameter adjustment result corresponding to each frame image in the first video, the working principle of the second network (the working principle of network 2 as shown in FIG. 2) may include: first, based on the body shape parameter adjustment result corresponding to the i-th frame image in the first video and the posture parameter prediction result corresponding to the i-th frame image (such as posture parameter θ), determining the state parameter adjustment result corresponding to the i-th frame image, so that the state parameter adjustment result include the body shape parameter adjustment result and the posture parameter prediction result; then, performing visualization processing on the state parameter adjustment result corresponding to the i-th frame image to obtain the visualization processing result corresponding to the i-th frame image, so that the visualization result can present the body shape and posture described by the state parameter adjustment result in an image manner; then performing the state feature extraction processing on the visualization processing result corresponding to the i-th frame image in the first video to obtain the state feature extraction result corresponding to the i-th frame image, so that the state feature extraction result can better describe the body shape and posture described by the state parameter adjustment result; then performing splicing on the state feature extraction result corresponding to the i-th frame image and the noise image randomly generated for the i-th frame image to obtain the splicing result corresponding to the i-th frame image, i is a positive integer, i≤the number of image frames in the first video; then, inputting the splicing results corresponding to all images in the first video into the second network, so that the second network can process these splicing results, such as the processing involved in the network 2 in FIG. 3. Among them, for part or all modules in the second network (such as at least one up-sampling module), the module can be used at least to perform cross-attention processing based on the semantic features of each frame image in the first video and the output data of the corresponding module in the above first network to improve the processing performance of the module.

It should be noted that the posture parameter prediction result corresponding to the i-th frame image in the first video above is obtained by performing posture parameter prediction processing (such as SMPL) on the i-th frame image, so that the posture parameter prediction result is used to describe the posture of the target object in the i-th frame image. In addition, the present application does not limit the implementation method of the posture parameter prediction processing. In addition, the present application does not limit the implementation method of the “visualization processing” in the above paragraph. For example, when the state parameter adjustment result corresponding to the i-th frame image is implemented using SMPL parameters, the visualization processing can be specifically: first, constructing a three-dimensional model based on the state parameter adjustment result, such as an SMPL model, so that the three-dimensional model can present the body shape and posture described by the state parameter adjustment result in three-dimensional space; then, performing two-dimensional image shooting processing on the three-dimensional model to obtain the visualization processing result corresponding to the i-th frame image, so that the visualization result can present the body shape and posture described by the state parameter adjustment result by means of an image, so that the visualization result can not only represent the body shape and posture described by the state parameter adjustment result, but also describe some spatial information corresponding to the body shape and posture, which is conducive to improving the video generation effect.

Based on the relevant content of the target model above, it can be known that in some scenarios, when S4 above is implemented by using the target model, S4 may specifically include the following steps 11 to 14.

Step 11: image feature extraction processing is performed on the i-th frame image in the first video, such as feature extraction 1 shown in FIG. 2, to obtain an image feature of the i-th frame image, so that the image feature is used to describe the image information carried by the i-th frame image, where i is a positive integer, i≤the number of image frames in the first video (F as shown in FIG. 3).

Step 12: semantic feature extraction processing is performed on the i-th frame image in the first video, such as CLIP shown in FIG. 2, to obtain the semantic feature of the i-th frame image, so that the semantic feature is used to describe the semantic information carried by the i-th frame image, where i is a positive integer, i≤the number of image frames in the first video (such as F shown in FIG. 3).

Step 13: according to the body shape parameter adjustment result corresponding to the i-th frame image in the first video, the state feature extraction result corresponding to the i-th frame image is determined, the output data of feature extraction 2 shown in FIG. 2, and splicing processing on the state feature extraction result corresponding to the i-th frame image and the noise image randomly generated for the i-th frame image is performed to obtain the splicing result corresponding to the i-th frame image, where i is a positive integer, i≤the number of image frames in the first video (F as shown in FIG. 3).

It should be noted that the present application does not limit the execution relationship between the above steps 11 to 13, for example, the three are executed simultaneously, or the three are executed in a certain order.

Step 14: processing is performed by the first network in the target model (network 1 as shown in FIG. 2 or FIG. 3) based on the image features of all images in the first video and the semantic features of all images to obtain output data of each module in the first network, and processing is performed by the second network in the target model (network 2 as shown in FIG. 2 or FIG. 3) based on the splicing results of all images in the first video, the semantic features of all images and the output data of part or all modules in the first network to obtain a second video, such as video 2 shown in FIG. 2.

Based on the relevant content of steps 11 to 14 above, it can be known that in some scenarios, for a first video, such as video 1 shown in FIG. 2, first obtain the image feature of each frame image in the first video, the semantic feature of each frame image in the first video, and the splicing result of each frame image in the first video; then input these image features, these semantic features and these splicing results into the target model, so that the target model can generate and output a second video based on these image features, these semantic features and these splicing results, such as video 2 shown in FIG. 2.

Among them, because the time sequence module in the target model has the performance of time sequence consistency optimization, the second video generated by using the target model can present a better time sequence consistency effect, so that various factors affecting time sequence consistency, such as background jumps, a sudden change in body shape, a sudden change in posture, etc., will not appear in the second video as much as possible, which is beneficial to improving the video generation effect, which is beneficial to improving the body shape adjustment effect.

In addition, by adding a time sequence module after each module in the UNet network, the present application achieves time sequence consistency optimization processing for each resolution in the UNet network, which is beneficial to expand the receptive field, thereby better improving the video generation effect, and further improving the body shape adjustment effect.

In addition, the present application introduces the time sequence information of each frame image in the first video, such as sinusoidal position coding, into the self-attention processing network of each time sequence module, so that the self-attention processing network can focus on the spatiotemporal positions of these images, which is conducive to better improving the time sequence consistency optimization effect, and further helps to improve the body shape adjustment effect.

Based on the relevant content of S1 to S4 above, it can be known that for the video generation method provided in the present application, a first video is first obtained so that each frame image in the first video includes the target object; secondly, for any frame image in the first video, a body shape parameter prediction processing is performed on the image to obtain a body shape parameter prediction result corresponding to the image, so that the body shape parameter prediction result is used to describe the body shape of the target object in the image; then, for any frame image in the first video, according to the body shape adjustment information specified for the target object (such as information such as losing 20%), adjustment processing is performed on the body shape parameter prediction result corresponding to the image to obtain a body shape parameter adjustment result corresponding to the image; finally, a second video is generated based on the first video and the body shape parameter adjustment result corresponding to each frame image in the first video, so that the second video is used to represent the body shape adjustment result for the first video, such as the i-th frame image in the second video is used to represent the body shape adjustment result for the i-th frame image in the first video, where i is a positive integer, and i≤the number of image frames in the second video or the number of image frames in the first video.

Among them, because the i-th frame image in the second video is generated based on the multiple frame images arranged in sequence in the first video and the body shape parameter adjustment results corresponding to the multiple frame images, and the distance between the arrangement position of each frame image in the multiple frame images in the first video and the arrangement position of the i-th frame image of the first video in the first video is not greater than the preset distance threshold, so that the i-th frame image in the second video can not only meet the body constraint described by the body shape parameter adjustment result corresponding to the i-th frame image in the first video, but also meet other constraints described by the multiple frame images except for the body shape, such as the time dependency of some information and other constraints, so that the second video has better time sequence consistency, which is conducive to improving the body shape adjustment effect.

In addition, in some scenarios, the time sequence module can be configured to achieve time sequence consistency optimization processing of a limited number of images. Therefore, in order to better meet this requirement, the present application also provides a possible implementation method of the above video generation method. In this embodiment, the video generation method may comprise the following steps 21-29.

Step 21: a long video provided by a user is obtained, the number of image frames in the long video is greater than a preset frame number threshold, wherein the preset frame number threshold is used to describe the maximum number of image frames that can be processed simultaneously by the above time sequence module.

Step 22: a plurality of video segments arranged in sequence is determined from the long video, so that the number of image frames in each video segment is equal to a preset frame number threshold, and the plurality of video segments can completely cover all images in the long video, and the first frame image in the video segments arranged at a relatively forward position is captured earlier in the long video than the first frame image in the video segments arranged at a relatively backward position.

It should be noted that the present application does not limit the implementation method of the above step 22. For example, it can be implemented by means of a sliding window.

It can be seen that in a possible implementation, when the window size of the sliding window is a preset frame number threshold (such as 24), and the sliding step (stride) of the sliding window is a preset step value (such as 20), step 22 can be specifically: using the sliding window, determining a plurality of video segments arranged in sequence from the long video, such as the first video segment including the first frame image to the 24th frame image, the second video segment including the 21 st frame image to the 44th frame image, the third video segment including the 41 st frame image to the 64th frame image, . . . (and so on), so that the number of image frames in each video segment is equal to the preset frame number threshold, and the number of image frames between the first frame images in any two adjacent video segments is the preset step value, and the arrangement position of the first frame image in the video segment with a smaller arrangement sequence number in the long video is ahead of the arrangement position of the first frame image in the video segment with a larger arrangement sequence number in the long video.

In addition, in some scenarios, for the long video mentioned above, after obtaining some video segments from the long video, if the number of frames of the remaining images in the long video is less than the preset frame number threshold, then in order to better ensure the time sequence consistency optimization effect, the insufficient images can be supplemented with all-black images, so that the video segment with the latest arrangement position obtained at the end includes these remaining images and some all-black images, and the number of image frames in the video segment with the latest arrangement position is equal to the preset frame number threshold.

In addition, in some scenarios, for the long video mentioned above, after some video segments are obtained from the long video, if the number of frames of the remaining images in the long video is less than the preset frame number threshold, then in order to better ensure the time sequence consistency optimization effect, these remaining images and some images existed in the long video that are relatively close to these remaining images can be used to construct the video segment with the latest arrangement position, so that the video segment with the latest arrangement position includes the multiple frame images with the latest arrangement position in the long video, and the number of image frames in the multiple frame images with the latest arrangement position is equal to the preset frame number threshold, so that the number of frame images overlapping between the video segment with the latest arrangement position and the video segment at the penultimate position is greater than the difference between the preset frame number threshold and the preset step value above (such as 4).

Step 23: the first video initialized using the video segment with the foremost arrangement position, so that the initial value of the first video segment includes the video segment with the foremost arrangement position.

Step 24: for any frame image in the first video, body shape parameter prediction processing is performed on the image to obtain a body shape parameter prediction result corresponding to the image, and the body shape parameter prediction result is used to describe the body shape of the target object in the image.

It should be noted that for the relevant content of step 24, please refer to the relevant content of S2 above.

Step 25: for any frame image in the first video, adjustment processing is performed on the body shape parameter prediction result corresponding to the image according to the body shape adjustment information specified for the target object to obtain the body shape parameter adjustment result corresponding to the image.

It should be noted that for the relevant content of step 25, please refer to the relevant content of S3 above.

Step 26: a second video corresponding to the first video is generated based on the target model, the first video, and the body shape parameter adjustment result corresponding to each frame image in the first video, wherein the i-th frame image in the second video is used to represent the body shape adjustment result for the i-th frame image in the first video, and the i-th frame image in the second video is generated based on multiple frame images arranged in sequence in the first video and the body shape parameter adjustment results corresponding to the multiple frame images, and the distance between the arrangement position of each frame image in the multiple frame images in the first video and the arrangement position of the i-th frame image in the first video is not greater than a preset distance threshold, i is a positive integer, and i≤the number of image frames in the second video or the number of image frames in the first video.

It should be noted that for the relevant content of step 26, please refer to the relevant content of S4 above.

Step 27: whether there are any untraversed video segments among the above multiple video segments is determined, if so, it can be determined that there are still some video segments that have not undergo body shape adjustment processing, so the following step 28 can be executed; if not, it can be determined that all video segments have completed body shape adjustment processing, so the following step 29 can be executed.

Step 28: If there are untraversed video segments among the above multiple video segments, the video segment with the foremost arrangement position among the untraversed video segments is used to update the first video, so that the updated first video includes the video segment with the foremost arrangement position among the untraversed video segments, and the above step 24 and its subsequent steps are returned to for the continuation of execution.

Step 29: If there is no untraversed video segment in the above multiple video segments, integration processing on the second videos corresponding to the multiple video segments are performed according to the arrangement order of the multiple video segments to obtain the body shape adjustment result corresponding to the above long video, so that the body shape adjustment result corresponding to the long video can represent the body shape adjustment result for each frame image in the long video.

It should be noted that the present application does not limit the implementation method of the above integration processing. For example, for any two video segments in the above multiple video segments that are adjacent in arrangement position, when the video segment in the front arrangement position of the two video segments is regarded as the first sequence, and the video segment in the back arrangement position of the two video segments is regarded as the second sequence, if the last R frame images in the first sequence overlaps with the first R frame images in the second sequence, the last R frame images in the second video corresponding to the first sequence and the first R frame images in the second video corresponding to the second sequence can be smoothed (such as averaging processing, etc.) to obtain an R frame smoothing result, so as to subsequently generate the body shape adjustment result corresponding to the above long video based on other images except for the last R frame images in the second video corresponding to the first sequence, the R frame smoothing result, and other images except for the first R frame images in the second video corresponding to the second sequence, so that the body shape adjustment result includes other images except for the last R frame images in the second video corresponding to the first sequence, the R frame smoothing result, and other images except for the first R frame images in the second video corresponding to the second sequence.

Based on the relevant content of steps 21 to 29 above, it can be known that in some scenarios, such as scenarios where the size of the input data of the time sequence module is fixed, if the user wants to perform body shape adjustment processing on a long video, the long video can be divided into multiple video segments first, and then the body shape adjustment processing is performed on each video segment. Finally, the body shape adjustment results of these video segments are integrated to obtain the body shape adjustment result corresponding to the long video. This can effectively meet the body shape adjustment processing of videos of different lengths, thereby helping to better improve the body shape adjustment effect.

In addition, the present application does not limit the training method of the above target model. For example, it can be implemented using any existing or future model training method, such as any diffusion model training method.

In addition, in order to better improve the model training effect, the present application also provides a training method for the above target model. In this method, when the target model includes at least one time sequence module, such as the time sequence module shown in FIG. 4, and for any time sequence module, the sum (or residual) between the output data of the time sequence module and the input data of the time sequence module is used as the input data of the next module corresponding to the time sequence module, the training process of the target model may include the following steps 31-32.

Step 31: part or all parameters of each time sequence module in the target model are set to zero, and the other parts of the target model except for at least one time sequence module are trained based on the first image and the second image, the object described by the first image and the object described by the second image is the same object. In this way, the first stage of training for the target model can be achieved, so that the trained target model can present better body shape adjustment performance on the image.

Among them, the first image refers to an image required to be used in the first stage of training and used to provide other information besides body shape for the image generation process.

The second image refers to an image required to be used in the first stage of training to provide a body shape for the image generation process, so that the second image can be used to determine the guidance information of the image generation process, such as the true value of noise and the true value of the image.

In addition, the step of “setting part or all parameters of each time sequence module in the target model to zero” in step 31 above is used to ensure that these time sequence modules do not work in the first stage of training, thereby ensuring that other parts of the target model except for at least one time sequence module can learn how to perform image-level body shape adjustment processing.

In addition, the present application does not limit the implementation method of the above step of “setting part or all parameters of each time sequence module in the target model to zero”. For example, in some scenarios, when the time sequence module includes a second conversion network, such as the Project out module shown in FIG. 4, the step can specifically be: setting the parameters of the second conversion network of each time sequence module in the target model to zero to ensure that the output data of each time sequence module is 0, thereby ensuring that these time sequence modules do not work in the first stage of training. In this way, the first stage of training can be achieved under the premise that relevant personnel perform as few setup operations as possible, thereby effectively avoiding defects that occur when relevant personnel perform a large number of setup operations, such as deleting time sequence modules, to achieve the first stage of training, such as time overhead, manpower overhead, and a high probability of manual errors.

In addition, the present application does not limit the implementation method of the above step 31, for example, it may include the following steps 311-315.

Step 311: the parameters of the second conversion network of each sequential module in the target model are set to zero to ensure that the output data of each sequential module is 0, thereby ensuring that these sequential modules do not work in the first stage of training.

It should be noted that the present application does not limit the execution time of step 311, and only needs to ensure that the execution time of step 311 is earlier than the execution time of step 314 below.

Step 312: a frame image is randomly extracted from the sample video as the first image, and another frame image is randomly extracted from the sample video as the second image, so that the object described by the first image is the same object as the object described by the second image.

Among them, the sample video refers to the video required for training the target model; and this application does not limit the method for obtaining the sample video.

Step 313: after obtaining the randomly generated noise for the second image, noise adding processing is performed on the second image using the noise to obtain a noise adding result corresponding to the second image (such as a noise image), and the randomly generated noise is regarded as the label noise corresponding to the second image, so that the label noise is used to represent the noise actually added to the second image.

Step 314: processing is performed by the target model based on the image features of the first image, the semantic features of the first image, the state parameter prediction result (such as SMPL parameters) corresponding to the second image, and the noise adding result corresponding to the second image to obtain the predicted noise corresponding to the second image, so that the predicted noise is used to represent the noise added for the prediction of the second image.

Step 315: based on the difference between the predicted noise corresponding to the second image and the label noise corresponding to the second image, the other parts of the target model except for at least one time sequence module is updated, and the above step 312 and its subsequent steps are returned to for the continuation of execution until the first preset stop condition is reached.

Among them, the first preset stop condition refers to the condition that needs to be met when the first stage of training ends; and the present application does not limit the implementation method of the first preset stop condition. For example, the first preset stop condition may include that the model loss of the target model is lower than a preset first loss threshold. For another example, the first preset stop condition may include that the rate of change of the model loss of the target model is lower than a preset first rate of change threshold. For another example, the first preset stop condition may include that the number of updates of other parts of the target model except for at least one time sequence module reaches a preset first number threshold.

In addition, the model loss of the target model is used to describe the performance of the target model; and in the first stage of training, the model loss of the target model can be determined based on the difference between the predicted noise corresponding to the second image and the label noise corresponding to the second image. It should be noted that this application does not limit the calculation method of the model loss, for example, it can be implemented using L2 loss.

Based on the relevant content of steps 311 to 315 above, it can be known that for the first stage of training, it is necessary to first set the parameters of the second conversion network of each time sequence module in the target model to zero; and then use some image pairs to train other parts of the target model except for at least one time sequence module, so that these parts can learn from these image pairs how to perform image-level body shape adjustment processing.

Through research, it is found that during the inference process, the target model is used to process multiple frame images simultaneously. Therefore, in order to better meet this demand, the present application also provides a possible implementation method of the first stage of training above. In this way, when the target model is used to process F frame images simultaneously, the first stage of training can at least meet the following constraints: for each round of training in the first stage of training, this round of training process is implemented using F first images randomly selected from the sample video and a second image corresponding to each first image, so that the target model can determine the predicted noise corresponding to each second image based on the F first images and the second image corresponding to each first image during this round of training.

It should be noted that the present application does not limit the processing method of other parts in the target model except for at least one time sequence module for F data (such as F first images, etc.). For example, the F data can be processed as a batch so that when the value of the input data of these parts in the size of b is F, the purpose of processing the F data simultaneously (or in parallel) by these parts can be achieved.

Based on the relevant content of step 31 above, it can be known that for the first stage of training of the target model, part or all parameters of each time sequence module in the target model are first set to zero; then some image pairs (such as the first image+the second image and other image pairs) are used to train the other parts of the target model except for at least one time sequence module, so that the other parts of the target model except for at least one time sequence module after the first stage of training can show better body shape adjustment performance on the image.

Step 32: the parameters of other parts of the target model except for at least one time sequence module are frozen, and at least one time sequence module in the target model is trained based on the first image sequence and the second image sequence, the object described by the first image sequence is the same object as the object described by the second image sequence. In this way, the second stage of training for the target model can be achieved, so that the trained target model can present better body shape adjustment performance in the video.

Among them, the first image sequence refers to an image sequence that is required to be used in the second stage of training and is used to provide information except for body shape for the video generation process. For example, the first image sequence may include the k-th frame image to the k+23-th frame image in the sample video, where k is a positive integer.

The second image sequence refers to an image sequence that is required to be used in the second stage of training and is used to provide a body shape for the video generation process, so that the second image sequence can be used to determine the guidance information of the video generation process, such as the true value of noise and the true value of the image. For example, the second image sequence may include the j-th frame image to the j+23-th frame image in the sample video, where j is a positive integer.

In addition, the present application does not limit the implementation method of the above step 32. For example, when the above preset frame number threshold=H, and the target model is used to process H images at the same time, H is a positive integer, the step 32 can specifically include the following steps 321-325.

Step 321: after completing the first training phase for the target model, the parameters of other parts of the target model except for at least one sequential module are frozen to ensure that the parameters of these parts are not updated in the second stage of training.

It should be noted that the present application does not limit the execution time of step 321, and only needs to ensure that the execution time of step 321 is earlier than the execution time of step 324 below.

Step 322: k and j are randomly generated so that both k and j are not greater than the number of image frames in the sample video, a first image sequence is constructed using the k-th image frame to the k+H-l-th image frame in the sample video, and a second image sequence is constructed using the j-th image frame to the j+H-l-th image frame in the sample video. Among them, k is a positive integer, j is a positive integer, k and j may be the same or different, and this application does not limit this.

Step 323: for any frame image in the second image sequence, after obtaining the randomly generated noise for the image, noise adding processing is performed on the image using the noise to obtain a noise adding result corresponding to the image (such as a noise image), and the randomly generated noise is regarded as the label noise corresponding to the image, so that the label noise is used to represent the noise actually added to the image.

Step 324: processing is performed by the target model based on the image features of each frame image in the first image sequence, the semantic features of each frame image in the first image sequence, the state parameter prediction result (such as SMPL parameters) corresponding to each frame image in the second image sequence, and the noise adding result corresponding to each frame image in the second image sequence, to obtain the predicted noise corresponding to each frame image in the second image sequence, so that the predicted noise is used to represent the noise added for the corresponding image prediction.

Step 325: based on the difference between the predicted noise corresponding to each frame image in the second image sequence and the label noise corresponding to each frame image in the second image sequence, at least one time sequence module in the target model is updated, and the above step 322 and its subsequent steps are returned to for the continuation of execution until the second preset stop condition is reached.

Among them, the second preset stop condition refers to the condition that needs to be met when the second stage of training ends; and the present application does not limit the implementation method of the second preset stop condition. For example, the second preset stop condition may include that the model loss of the target model is lower than a preset second loss threshold. For another example, the second preset stop condition may include that the rate of change of the model loss of the target model is lower than a preset second rate of change threshold. For another example, the second preset stop condition may include that the number of updates of at least one time sequence module in the target model reaches a preset second number threshold.

In addition, the model loss of the target model is used to describe the performance of the target model; and in the second stage of training, the model loss of the target model can be determined based on the difference between the predicted noise corresponding to each frame image in the second image sequence and the label noise corresponding to each frame image in the second image sequence. It should be noted that this application does not limit the calculation method of the model loss, for example, it can be implemented using L2 loss.

Based on the relevant content of steps 321 to 325 above, it can be known that for the target model, after completing the first stage of training for the target model, all parts of the target model except for at least one time sequence module have relatively good performance. Therefore, in order to avoid interference with the other parts caused by subsequent training, the other parts can be directly frozen to ensure that the parameters of the other parts are not updated in the subsequent training, thereby ensuring that in the subsequent training, the at least one time sequence module is guided to learn how to perform time sequence consistency optimization processing through parameter updating, so that the finally trained target model can learn how to perform video-level body shape adjustment processing.

In addition, in order to better improve the model performance, the present application also provides a possible implementation of the above step 32, in which the step 32 may at least include the following steps 326-331.

Step 326: label noise corresponding to each frame image in the second image sequence is obtained.

It should be noted that the present application does not limit the implementation method of the above step 326. For example, it can be implemented in a random generation manner.

Step 327: for any frame image in the second image sequence, noise adding processing is performed on the image according to the label noise corresponding to the image to obtain a noise adding result (such as a noise image) corresponding to the image.

Step 328: Based on the target model, the first image sequence, the body shape parameter prediction result corresponding to each frame image in the second image sequence, and the noise adding result corresponding to each frame image in the second image sequence, the prediction information corresponding to each frame image in the second image sequence is determined, where the prediction information includes predicted noise and predicted image.

Among them, for any frame image of the second image sequence above, the prediction information corresponding to the image is used to describe some information predicted for the image, such as noise prediction results and image generation results; and the prediction information corresponding to the image may include the predicted noise corresponding to the image and the predicted image corresponding to the image. The predicted noise corresponding to the image is used to describe the noise added for the image prediction. The predicted image corresponding to the image is used to describe the information carried by the image prediction.

In addition, the present application does not limit the implementation method of the above step 328. For example, in some scenarios, the step 328 can specifically be: based on the target model, the first image sequence, the state parameter prediction result corresponding to each frame image in the second image sequence (such as SMPL parameters), and the noise adding result corresponding to each frame image in the second image sequence, determining the prediction information corresponding to each frame image in the second image sequence.

Step 329: a first loss is determined based on the label noise corresponding to each frame image in the second image sequence and the predicted noise corresponding to each frame image in the second image sequence, so that the first loss can represent the performance of the target model.

It should be noted that the present application does not limit the implementation method of the above step 329. For example, it can be implemented with the help of L2 loss.

Step 330: a second loss is determined based on the region segmentation result of each frame image in the second image sequence, the object position detection result of each frame image in the second image sequence, and the region segmentation result of the predicted image corresponding to each frame image in the second image sequence, so that the second loss can represent the prediction performance of the target model in terms of the object state.

Among them, for any frame image of the second image sequence above, the region segmentation result of the image is used to describe the position of each part of the foreground in the image, so that the region segmentation result can represent the state of the foreground in the image, such as body shape and posture, so that the region segmentation result can be used as guidance information to guide the target model to better optimize its prediction performance in the foreground state. It should be noted that the present application does not limit the method for obtaining the region segmentation result. For example, it can be implemented using any image segmentation method, such as a foreground segmentation method.

In addition, for any frame image in the second image sequence above, the object position detection result of the image is used to describe the position of the foreground in the image, so that the object position detection result can describe the layout structure in the image, so that the object position detection result can be used as guidance information to guide the target model to better optimize its prediction performance in the foreground state. It should be noted that the present application does not limit the implementation method of the object position detection result, for example, it can be implemented using a bounding box or a foreground mask map; and the present application does not limit the method for obtaining the object position detection result, for example, it can be implemented using any target detection method.

In addition, for any frame image in the second image sequence above, the regional segmentation result of the predicted image corresponding to the image is used to describe the position of each part of the foreground in the predicted image, so that the regional segmentation result can represent the state of the foreground in the predicted image, such as body shape and posture, etc., so that the regional segmentation result can represent the foreground prediction information for the image, such as prediction information for each part of the image, etc., so that the prediction performance of the target model in terms of object state can be measured based on the regional segmentation result. It should be noted that the present application does not limit the method for obtaining the regional segmentation result. For example, it can be implemented using any image segmentation method, such as a foreground segmentation method.

In addition, the present application does not limit the implementation method of the above step 330. For example, it can be specifically as follows: for any frame image in the above second image sequence, first calculating the difference (such as distance) between the region segmentation result of the image and the region segmentation result of the predicted image corresponding to the image, so that the difference can represent the difference between the two images in the entire image range; then multiplying the difference with the object position detection result of the image (such as the foreground mask map) to obtain the state prediction loss corresponding to the image, so that the state prediction loss can represent the difference between the two images in the foreground range, so that the second loss can be determined based on the state prediction losses corresponding to all images in the second image sequence, so that the second loss can represent the prediction performance of the target model in terms of object state.

Step 331: at least one time sequence module in the target model is updated according to the sum of the first loss and the second loss.

Based on the relevant content of steps 326 to 331 above, it can be known that in the second stage of training, it is necessary not only to calculate the loss between the predicted noise and the label noise, but also to further calculate the loss between the object state described by each frame image in the second image sequence and the object state described by the predicted image corresponding to the corresponding image, so that the object state presented in the predicted image generated by the target model is as consistent as possible with the object state presented in the image true value corresponding to the predicted image, so that the target model can better learn how to predict the object state in the second stage of training, which is beneficial to improving the model training effect.

In addition, in order to better improve the model performance, the present application also provides a possible implementation of the above step 32, in which the step 32 may at least include the following steps 332-335.

Step 332: the first image sequence, the second image sequence, and label information corresponding to each frame image in the second image sequence are obtained.

Among them, for any frame image in the second image sequence above, the label information corresponding to the image refers to the true value information associated with the image, such as the noise true value and the image true value, so that the label information can be used as guidance information to guide the target model to generate and process the image.

In addition, the present application does not limit the implementation method of the above label information. For example, in some scenarios, for any frame image in the second image sequence above, the label information corresponding to the image may include the label noise corresponding to the image, so that the label information can describe the noise actually added to the image.

For another example, in some scenarios, for any frame image in the second image sequence above, the label information corresponding to the image may include the label noise corresponding to the image and the image, so that the label information can not only describe the noise actually added to the image, but also represent the true value of the image obtained by denoising the noise adding result corresponding to the image.

It can be seen that, in a possible implementation manner, for any frame image in the second image sequence above, the process of obtaining the label information corresponding to the image can be: first, directly regarding the image as the label image corresponding to the image, so that the label image can represent the information actually carried by the image, so that the label image can represent the true value of the image obtained by denoising the noise adding result corresponding to the image; then, based on the label image corresponding to the image and the label noise corresponding to the image, determining the label information corresponding to the image, so that the label information includes the label image and the label noise.

Step 333: mask processing is performed on at least one frame image of the first image sequence to obtain a processed sequence, the processed sequence including the mask processing result of the at least one frame image, for any frame image of the at least one frame image, the information described by the mask processing result of the image is less than the information described by the image.

Among them, that mask processing is used for deleting part or all information in an image; moreover, the mask processing is not limited in this application, for example, it can specifically be: adjusting part or all pixel values in the image to preset pixel values, such as pixel values used to represent black.

Based on the relevant content of step 333 above, it can be known that for some scenarios, after obtaining the first image sequence, one or more frame images can be randomly selected from the first image sequence for mask processing, such as replacing them with completely black images, to obtain a processed sequence, so that there are some images in the processed sequence that have lost part or all of the information, so that these images that have lost part or all of the information cannot provide sufficient image information for the corresponding image generation processing, thereby enabling the target model to better learn how to perform image generation processing based on other information (such as adjacent images, object status, etc.), which can effectively prevent the model from only learning reference images (such as each frame image in the first image sequence) and ignoring other information (such as SMPL parameters, etc.) when the training model is overfitted.

Step 334: prediction information corresponding to each frame image in the second image sequence is determined according to the target model, the processed sequence, and the body shape parameter prediction result corresponding to each frame image in the second image sequence.

It should be noted that the present application does not limit the implementation method of step 334 above. For example, the implementation method of step 334 is similar to the implementation method of step 328 above. For the sake of brevity, it will not be repeated here.

Step 335: at least one time sequence module in the target model is updated according to the prediction information corresponding to each frame image in the second image sequence and the label information corresponding to each frame image in the second image sequence.

Based on the relevant content of steps 332 to 335 above, it can be known that for the second stage of training, after obtaining the first image sequence, random mask processing can be performed on the first image sequence so that part of the images in the first image sequence are replaced with completely black images. This is helpful to increase the disturbance of the data, thereby effectively preventing the model from only learning the reference image (such as each frame image in the first image sequence) and ignoring other information guidance when the training model is overfitted, which is beneficial to improving the model training effect.

Based on the relevant content of steps 31 to 32 above, it can be known that in some scenarios, the training process for the target model can be completed with the help of a two-stage training method, so that the trained target model has better video generation performance, so that the video generated using the target model presents better effects, such as time sequence consistency, etc., which is conducive to improving the body shape adjustment effect.

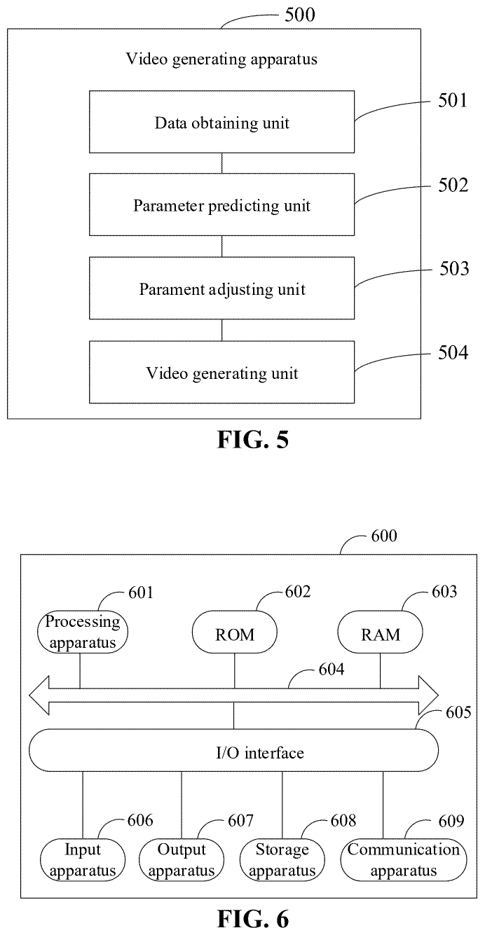

Based on the video generation method provided in the embodiment of the present application, the embodiment of the present application also provides a video generation apparatus, which is explained and illustrated in conjunction with FIG. 5. FIG. 5 is a schematic diagram of the structure of a video generation apparatus provided in the embodiment of the present application. It should be noted that for the technical details of the video generation apparatus provided in the embodiment of the present application, please refer to the relevant content of the video generation method above.

As shown in FIG. 5, the video generation apparatus 500 provided in the embodiment of the present application comprises:
a data obtaining unit 501, configured to obtain a first video, each frame image in the first video including a target object;
a parameter predicting unit 502, configured to perform body shape parameter prediction processing on any frame image in the first video to obtain a body shape parameter prediction result corresponding to the image, the body shape parameter prediction result is used to describe the body shape of the target object in the image;
a parameter adjusting unit 503, configured to, for any frame image in the first video, perform adjustment processing on the body shape parameter prediction result corresponding to the frame image according to the body shape adjustment information specified for the target object, to obtain the body shape parameter adjustment result corresponding to the image; and
a video generating unit 504, configured to generate a second video based on the first video and the body shape parameter adjustment result corresponding to each frame image in the first video, the i-th frame image in the second video is used to represent the body shape adjustment result for the i-th frame image in the first video, and the i-th frame image in the second video is generated based on multiple frame images arranged in sequence in the first video and the body shape parameter adjustment results corresponding to the multiple frame images, and the distance between the arrangement position of each frame image in the multiple frame images in the first video and the arrangement position of the i-th frame image in the first video is not greater than a preset distance threshold, i is a positive integer, and i≤the number of image frames in the second video or the number of image frames in the first video.

In one possible implementation, the body shape described by the i-th frame image in the second video is different from the body shape described by the i-th frame image in the first video, and other information except for the body shape described by the i-th frame image in the second video is consistent with other information except for the body shape described by the i-th frame image in the first video.

In a possible implementation manner, the body shape parameter prediction result corresponding to each frame image in the second video remains consistent.

In one possible implementation, the second video is generated using a target model; the target model includes at least one processing unit, the processing unit includes an image-level processing module and a time sequence module, the image-level processing module is configured to separately implement a separate processing procedure for each frame image of the multiple frame images, and the time sequence module is configured to perform attention processing on the execution results of the separate processing procedures for the multiple frame images in the time direction.

In one possible implementation, the at least one processing unit includes multiple up-sampling modules, time sequence modules corresponding to each of the up-sampling modules, multiple down-sampling modules, and time sequence modules corresponding to each of the down-sampling modules; for any of the up-sampling modules, the time sequence module corresponding to the up-sampling module is configured to perform attention processing on the output data of the up-sampling module in the time direction; for any of the down-sampling modules, the time sequence module corresponding to the down-sampling module is configured to perform attention processing on the output data of the down-sampling module in the time direction.

In one possible implementation, the attention processing is also implemented based on the time information of each frame image of the multiple frames; for any frame image of the multiple frame images, the time information of the image is used to describe the arrangement position of the image in the first video.

In one possible implementation, the time sequence module includes an integration network, a first conversion network, at least one self-attention network, a second conversion network and a splitting network; the integration network is configured to perform integration processing on the input data of the time sequence module to obtain an integration result, the size of the integration result is different from the size of the input data of the time sequence module, and the input data of the time sequence module includes the execution results of separate processing procedures for the multiple frame images; the first conversion network is configured to convert the integration result from a first expression to a second expression to obtain a first conversion result, the first expression is used to describe image features, and the second expression is used to describe video features; the at least one self-attention network is configured to perform self-attention processing on the first conversion result to obtain a self-attention processing result; the second conversion network is configured to convert the self-attention processing result from the second expression to the first expression to obtain a second conversion result; the splitting network is configured to perform splitting processing on the second conversion result to obtain a splitting result, and the size of the splitting result is the same as the size of the input data of the time sequence module.

In a possible implementation manner, the second video is generated using a target model; the target model includes at least one time sequence module;

the training process of the target model comprises: setting part or all of the parameters of each time sequence module in the target model to zero, and training the other parts of the target model except for the at least one time sequence module based on the first image and the second image, and the object described by the first image is the same object as the object described by the second image; freezing the parameters of the other parts of the target model except for the at least one time sequence module, and training at least one time sequence module in the target model based on the first image sequence and the second image sequence, and the object described by the first image sequence is the same object as the object described by the second image sequence.

In a possible implementation manner, the time sequence module includes a second conversion network; and the training process of the target model specifically comprises: setting the parameters of the second conversion network of each time sequence module in the target model to zero.

In one possible implementation, the training process of the at least one time sequence module comprises: obtaining the first image sequence, the second image sequence, and label information corresponding to each frame image in the second image sequence; performing mask processing on at least one frame image in the first image sequence to obtain a processed sequence, the processed sequence including the mask processing result of the at least one frame image, and for any frame image in the at least one frame image, the information described by the mask processing result of the image is less than the information described by the image; determining the prediction information corresponding to each frame image in the second image sequence based on the target model, the processed sequence, and the body shape parameter prediction result corresponding to each frame image in the second image sequence; and updating at least one time sequence module in the target model based on the prediction information corresponding to each frame image in the second image sequence and the label information corresponding to each frame image in the second image sequence.

In a possible implementation manner, the training process of the at least one time sequence module comprises: obtaining label noise corresponding to each frame image in the second image sequence; for any frame image in the second image sequence, performing noise adding processing on the image according to the label noise corresponding to the image, and obtaining a noise adding result corresponding to the image; determining prediction information corresponding to each frame image in the second image sequence according to the target model, the first image sequence, the body shape parameter prediction result corresponding to each frame image in the second image sequence, and the noise adding result corresponding to each frame image in the second image sequence, the prediction information including predicted noise and predicted image; determining a first loss according to the label noise corresponding to each frame image in the second image sequence and the predicted noise corresponding to each frame image in the second image sequence; determining a second loss according to a region segmentation result of each frame image in the second image sequence, an object position detection result of each frame image in the second image sequence, and a region segmentation result of the predicted image corresponding to each frame image in the second image sequence; and updating at least one time sequence module in the target model according to the sum of the first loss and the second loss.

Based on the relevant content of the above-mentioned video generation apparatus 500, it can be known that the working principle of the video generation apparatus 500 provided in the present application is: first, obtaining a first video so that each frame image in the first video includes a target object; secondly, for any frame image in the first video, performing a body shape parameter prediction processing on the image to obtain a body shape parameter prediction result corresponding to the image, so that the body shape parameter prediction result is used to describe the body shape of the target object in the image; then, for any frame image in the first video, according to the body shape adjustment information specified for the target object (such as information such as losing 20%), performing an adjustment processing on the body shape parameter prediction result corresponding to the image to obtain a body shape parameter adjustment result corresponding to the image; finally, generating a second video based on the first video and the body shape parameter adjustment result corresponding to each frame image in the first video, so that the second video is used to represent the body shape adjustment result for the first video, such as the i-th frame image in the second video is used to represent the body shape adjustment result for the i-th frame image in the first video, i is a positive integer, and i≤the number of image frames in the second video or the number of image frames in the first video. Among them, because the i-th frame image in the second video is generated based on the multiple frame images arranged in sequence in the first video and the body shape parameter adjustment results corresponding to the multiple frame images, and the distance between the arrangement position of each frame image in the multiple frame images in the first video and the arrangement position of the i-th frame image of the first video in the first video is not greater than the preset distance threshold, so that the i-th frame image in the second video can not only meet the body constraint described by the body shape parameter adjustment result corresponding to the i-th frame image in the first video, but also meet other constraints described by the multiple frame images except for the body shape, such as the time dependency of some information and other constraints, so that the second video has better time sequence consistency, which is conducive to improving the body shape adjustment effect.

In addition, an embodiment of the present application also provides an electronic device, which includes a processor and a memory: the memory is configured to store instructions or computer programs; the processor is configured to execute the instructions or computer programs in the memory, so that the electronic device executes any implementation of the video generation method provided in the embodiment of the present application.

Referring to FIG. 6, a schematic diagram of the structure of an electronic device 600 suitable for implementing the embodiment of the present disclosure is shown. The terminal device in the embodiment of the present disclosure may include, but is not limited to, mobile terminals such as mobile phones, laptop computers, digital broadcast receivers, PDAs (personal digital assistants), PADs (tablet computers), PMPs (portable multimedia players), vehicle-mounted terminals (such as vehicle-mounted navigation terminals), etc., and fixed terminals such as digital TVs, desktop computers, etc. The electronic device shown in FIG. 6 is only an example and should not bring any limitation to the functions and scope of use of the embodiment of the present disclosure.

As shown in FIG. 6, the electronic device 600 may include a processing apparatus (e.g., a central processing unit, a graphics processing unit, etc.) 601, which can perform various appropriate actions and processes according to a program stored in a read-only memory (ROM) 602 or a program loaded from a storage apparatus 608 into a random access memory (RAM) 603. In the RAM 603, various programs and data required for the operation of the electronic device 600 are also stored. The processing apparatus 601, the ROM 602, and the RAM 603 are connected to each other via a bus 604. An input/output (I/O) interface 605 is also connected to the bus 604.

Typically, the following apparatus may be connected to the I/O interface 605: input apparatus 606 including, for example, a touch screen, a touchpad, a keyboard, a mouse, a camera, a microphone, an accelerometer, a gyroscope, etc.; output apparatus 607 including, for example, a liquid crystal display (LCD), a speaker, a vibrator, etc.; storage apparatus 608 including, for example, a magnetic tape, a hard disk, etc.; and communication apparatus 609. The communication apparatus 609 may allow the electronic device 600 to communicate with other devices wirelessly or by wire to exchange data. Although FIG. 6 shows an electronic device 600 with various devices, it should be understood that it is not required to implement or have all the devices shown. More or fewer devices may be implemented or have alternatively.

In particular, according to an embodiment of the present disclosure, the process described above with reference to the flowchart can be implemented as a computer software program. For example, an embodiment of the present disclosure includes a computer program product, which includes a computer program carried on a non-transitory computer-readable medium, and the computer program contains program code for executing the method shown in the flowchart. In such an embodiment, the computer program can be downloaded and installed from the network through the communication apparatus 609, or installed from the storage apparatus 608, or installed from the ROM 602. When the computer program is executed by the processing apparatus 601, the above-mentioned functions defined in the method of the embodiment of the present disclosure are executed.

The electronic device provided by the embodiment of the present disclosure and the method provided by the above embodiment belong to the same inventive concept, and the technical details not fully described in this embodiment can be referred to the above embodiment, and this embodiment has the same beneficial effects as the above embodiment.

The embodiment of the present application also provides a computer-readable medium, in which instructions or computer programs are stored. When the instructions or computer programs are executed on a device, the device executes any implementation of the video generation method provided in the embodiment of the present application.

It should be noted that the computer-readable medium mentioned above in the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, device or device, or any combination of the above. More specific examples of computer-readable storage media may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in combination with an instruction execution system, device or device. In the present disclosure, a computer-readable signal medium may include a data signal propagated in a baseband or as part of a carrier wave, which carries a computer-readable program code. This propagated data signal may take a variety of forms, including but not limited to an electromagnetic signal, an optical signal, or any suitable combination of the above. Computer readable signal media may also be any computer readable medium except for computer readable storage media, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

In some embodiments, the client and server may communicate using any currently known or future developed network protocol such as HTTP (Hyper Text Transfer Protocol), and may be interconnected with any form or medium of digital data communication (e.g., a communication network). Examples of communication networks include a local area network (“LAN”), a wide area network (“WAN”), an internet (e.g., the Internet), and a peer-to-peer network (e.g., an ad hoc peer-to-peer network), as well as any currently known or future developed network.

The computer-readable medium may be included in the electronic device, or may exist independently without being incorporated into the electronic device.

The computer-readable medium carries one or more programs, and when the one or more programs are executed by the electronic device, the electronic device can execute the method.

Computer program code for performing the operations of the present disclosure may be written in one or more programming languages or a combination thereof, including, but not limited to, object-oriented programming languages, such as Java, Smalltalk, C++, and conventional procedural programming languages, such as “C” or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer through any type of network, including a local area network (LAN) or a wide area network (WAN), or may be connected to an external computer (e.g., through the Internet using an Internet service provider).

The flow chart and block diagram in the accompanying drawings illustrate the possible architecture, function and operation of the system, method and computer program product according to various embodiments of the present disclosure. In this regard, each square box in the flow chart or block diagram can represent a module, a program segment or a part of a code, and the module, the program segment or a part of the code contains one or more executable instructions for realizing the specified logical function. It should also be noted that in some implementations as replacements, the functions marked in the square box can also occur in a sequence different from that marked in the accompanying drawings. For example, two square boxes represented in succession can actually be executed substantially in parallel, and they can sometimes be executed in the opposite order, depending on the functions involved. It should also be noted that each square box in the block diagram and/or flow chart, and the combination of the square boxes in the block diagram and/or flow chart can be implemented with a dedicated hardware-based system that performs a specified function or operation, or can be implemented with a combination of dedicated hardware and computer instructions.

The units involved in the embodiments described in the present disclosure may be implemented by software or hardware, wherein the name of a unit/module does not, in some cases, constitute a limitation on the unit itself.

The functions described above herein may be performed at least in part by one or more hardware logic components. For example, without limitation, exemplary types of hardware logic components that may be used include: field programmable gate arrays (FPGAs), application specific integrated circuits (ASICs), application specific standard products (ASSPs), systems on chips (SOCs), complex programmable logic devices (CPLDs), and the like.

In the context of the present disclosure, a machine-readable medium may be a tangible medium that may contain or store a program for use by or in conjunction with an instruction execution system, device, or equipment. A machine-readable medium may be a machine-readable signal medium or a machine-readable storage medium. A machine-readable medium may include, but is not limited to, an electronic, magnetic, optical, electromagnetic, infrared, or semiconductor system, device, or device, or any suitable combination of the foregoing. A more specific example of a machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

It should be noted that the various embodiments in this specification are described in a progressive manner, and each embodiment focuses on the differences from other embodiments, and the same or similar parts between the various embodiments can be referred to each other. For the system or device disclosed in the embodiment, since it corresponds to the method disclosed in the embodiment, the description is relatively simple, and the relevant parts can be referred to the method part description.

It should be understood that in this application, “at least one (item)” means one or more, and “plurality” means two or more. “And/or” is used to describe the association relationship of associated objects, indicating that three relationships may exist. For example, “A and/or B” can mean: only A exists, only B exists, and A and B exist at the same time, where A and B can be singular or plural. The character “/” generally indicates that the objects associated before and after are in an “or” relationship. “At least one of the following” or similar expressions refers to any combination of these items, including any combination of single or plural items. For example, at least one of a, b or c can mean: a, b, c, “a and b”, “a and c”, “b and c”, or “a and b and c”, where a, b, c can be single or multiple.

It should also be noted that, in this article, relational terms such as first and second, etc. are only used to distinguish one entity or operation from another entity or operation, and do not necessarily require or imply any such actual relationship or order between these entities or operations. Moreover, the terms “include”, “comprise” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, the elements defined by the sentence “comprise a . . . ” do not exclude the presence of other identical elements in the process, method, article or device including the elements.

The steps of the method or algorithm described in conjunction with the embodiments disclosed herein may be implemented directly using hardware, a software module executed by a processor, or a combination of the two. The software module may be placed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The above description of the disclosed embodiments enables those skilled in the art to implement or use the present application. Various modifications to these embodiments will be apparent to those skilled in the art, and the general principles defined herein may be implemented in other embodiments without departing from the spirit or scope of the present application. Therefore, the present application will not be limited to the embodiments shown herein, but will conform to the widest scope consistent with the principles and novel features disclosed herein.

I/We claim:

1. A video generation method, comprising:
obtaining a first video, at least one frame image in the first video comprising a target object;
for the at least one frame image in the first video, obtaining a body shape parameter prediction result corresponding to the frame image by performing body shape parameter prediction processing on the frame image, the body shape parameter prediction result being used to describe a body shape of the target object in the frame image;
for any frame image in the first video, obtaining a body shape parameter adjustment result corresponding to the frame image by performing adjustment processing on the body shape parameter prediction result corresponding to the frame image according to body shape adjustment information specified for the target object; and
generating a second video according to the first video and a body shape parameter adjustment result corresponding to the at least one frame image in the first video, the i-th frame image in the second video being used to represent a body shape parameter adjustment result for the i-th frame image in the first video, the i-th frame image in the second video being generated according to a plurality of frame images arranged in sequence in the first video and body shape parameter adjustment results corresponding to the plurality of frame images, a distance between an arrangement position of at least one frame image of the plurality of frame images in the first video and an arrangement position of the i-th frame image in the first video being not greater than a preset distance threshold, i being a positive integer, and i being less than or equal to a number of image frames in the second video or a number of image frames in the first video.

2. The method according to claim 1, wherein a body shape described by the i-th frame image in the second video is different from a body shape described by the i-th frame image in the first video, and other information except for the body shape described by the i-th frame image in the second video is consistent with information described by the i-th frame image in the first video except for the body shape; and/or,
the body shape parameter prediction result corresponding to at least one frame image in the second video remains consistent.

3. The method according to claim 1, wherein the second video is generated using a target model; and
the target model comprises at least one processing unit, the processing unit comprises an image-level processing module and a time sequence module, the image-level processing module is configured to separately implement a separate processing procedure for the at least one frame image of the plurality of frame images, and the time sequence module is configured to perform attention processing on execution results of separate processing procedures for the plurality of frame images in a time direction.

4. The method according to claim 3, wherein the at least one processing unit comprises a plurality of up-sampling modules, a time sequence module corresponding to at least one of the up-sampling module, a plurality of down-sampling modules, and a time sequence module corresponding to at least one of the down-sampling module;
for any up-sampling module of the up-sampling modules, a time sequence module corresponding to the up-sampling module is configured to perform attention processing on output data of the up-sampling module in the time direction; and
for any down-sampling module of the down-sampling modules, a time sequence module corresponding to the down-sampling module is configured to perform attention processing on output data of the down-sampling module in the time direction.

5. The method according to claim 3, wherein the attention processing is further implemented according to time information of the at least one frame image of the plurality of frame images; and
for any frame image of the plurality of frame images, time information of the frame image is configured to describe an arrangement position of the frame image in the first video.

6. The method according to claim 3, wherein the time sequence module comprises an integration network, a first conversion network, at least one self-attention network, a second conversion network, and a splitting network;
the integration network is configured to perform integration processing on input data of the time sequence module to obtain an integration result, a size of the integration result being different from a size of the input data of the time sequence module, and the input data of the time sequence module comprising the execution results of separate processing procedures for the plurality of frame images;
the first conversion network is configured to convert the integration result from a first expression to a second expression to obtain a first conversion result, the first expression being used for describing an image feature, and the second expression being used for describing a video feature;
the at least one self-attention network is configured to perform self-attention processing on the first conversion result to obtain a self-attention processing result;
the second conversion network is configured to convert the self-attention processing result from the second expression to the first expression to obtain a second conversion result; and
the splitting network is configured to perform splitting processing on the second conversion result to obtain a splitting result, a size of the splitting result being the same as a size of the input data of the time sequence module.

7. The method according to claim 1, wherein the second video is generated using a target model;
the target model comprises at least one time sequence module; and
a training process of the target model comprises:
setting part or all parameters of the at least one time sequence module in the target model to zero, and training other parts of the target model except for the at least one time sequence module according to a first image and a second image, an object described by the first image being the same as an object described by the second image; and
freezing parameters of other parts of the target model except for the at least one time sequence module, and training the at least one time sequence module in the target model according to a first image sequence and a second image sequence, an object described by the first image sequence being the same as an object described by the second image sequence.

8. The method according to claim 7, wherein the time sequence module comprises a second conversion network; and
setting part or all parameters of the at least one time sequence module in the target model to zero comprises:
setting a parameter of the second conversion network of the at least one time sequence module in the target model to zero.

9. The method according to claim 7, wherein a training process of the at least one time sequence module comprises:
obtaining the first image sequence, the second image sequence, and label information corresponding to at least one frame image in the second image sequence;
obtaining a processed sequence by performing mask processing on at least one frame image in the first image sequence, the processed sequence comprising a mask processing result of the at least one frame image, and for any frame image of the at least one frame image, information described by a mask processing result of the frame image being less than information described by the frame image;
determining prediction information corresponding to the at least one frame image in the second image sequence according to the target model, the processed sequence and the body shape parameter prediction result corresponding to the at least one frame image in the second image sequence; and
updating the at least one time sequence module in the target model according to the prediction information corresponding to the at least one frame image in the second image sequence and the label information corresponding to the at least one frame image in the second image sequence.

10. The method according to claim 7, wherein the training process of the at least one time sequence module comprises:
obtaining label noise corresponding to at least one frame image in the second image sequence;
for any frame image in the second image sequence, obtaining a noise adding result corresponding to the frame image by performing noise adding processing on the frame image according to the label noise corresponding to the frame image;
determining prediction information corresponding to the at least one frame image in the second image sequence according to the target model, the first image sequence, the body shape parameter prediction result corresponding to the at least one frame image in the second image sequence, and a noise adding result corresponding to the at least one frame image in the second image sequence, the prediction information comprising predicted noise and a predicted image;
determining a first loss according to the label noise corresponding to the at least one frame image in the second image sequence and the predicted noise corresponding to the at least one frame image in the second image sequence;
determining a second loss according to a region segmentation result of the at least one frame image in the second image sequence, an object position detection result of the at least one frame image in the second image sequence, and a region segmentation result of a predicted image corresponding to the at least one frame image in the second image sequence; and
updating the at least one time sequence module in the target model according to a sum between the first loss and the second loss.

11. An electronic device comprising: a processor and a memory;
the memory, configured to store instructions or computer programs;
the processor, configured to execute the instructions or the computer programs in the memory, for causing the electronic device to:
obtain a first video, at least one frame image in the first video comprising a target object;
for any frame image in the first video, obtain a body shape parameter prediction result corresponding to the frame image by performing body shape parameter prediction processing on the frame image, the body shape parameter prediction result being used to describe a body shape of the target object in the frame image;
for any frame image in the first video, obtain a body shape parameter adjustment result corresponding to the frame image by performing adjustment processing on the body shape parameter prediction result corresponding to the frame image according to body shape adjustment information specified for the target object; and
generate a second video according to the first video and a body shape parameter adjustment result corresponding to the at least one frame image in the first video, the i-th frame image in the second video being used to represent a body shape parameter adjustment result for the i-th frame image in the first video, the i-th frame image in the second video being generated according to a plurality of frame images arranged in sequence in the first video and body shape parameter adjustment results corresponding to the plurality of frame images, a distance between an arrangement position of at least one frame image of the plurality of frame images in the first video and an arrangement position of the i-th frame image in the first video being not greater than a preset distance threshold, i being a positive integer, and i being less than or equal to a number of image frames in the second video or a number of image frames in the first video.

12. The electronic device according to claim 11, wherein a body shape described by the i-th frame image in the second video is different from a body shape described by the i-th frame image in the first video, and other information except for the body shape described by the i-th frame image in the second video is consistent with information described by the i-th frame image in the first video except for the body shape; and/or,
the body shape parameter prediction result corresponding to at least one frame image in the second video remains consistent.

13. The electronic device according to claim 11, wherein the second video is generated using a target model; and
the target model comprises at least one processing unit, the processing unit comprises an image-level processing module and a time sequence module, the image-level processing module is configured to separately implement a separate processing procedure for the at least one frame image of the plurality of frame images, and the time sequence module is configured to perform attention processing on execution results of separate processing procedures for the plurality of frame images in a time direction.

14. The electronic device according to claim 13, wherein the at least one processing unit comprises a plurality of up-sampling modules, a time sequence module corresponding to at least one of the up-sampling module, a plurality of down-sampling modules, and a time sequence module corresponding to at least one of the down-sampling module;
for any up-sampling module of the up-sampling modules, a time sequence module corresponding to the up-sampling module is configured to perform attention processing on output data of the up-sampling module in the time direction; and
for any down-sampling module of the down-sampling modules, a time sequence module corresponding to the down-sampling module is configured to perform attention processing on output data of the down-sampling module in the time direction.

15. The electronic device according to claim 13, wherein the attention processing is further implemented according to time information of the at least one frame image of the plurality of frame images; and
for the at least one frame image of the plurality of frame images, time information of the frame image is configured to describe an arrangement position of the frame image in the first video.

16. The electronic device according to claim 13, wherein the time sequence module comprises an integration network, a first conversion network, at least one self-attention network, a second conversion network, and a splitting network;
the integration network is configured to perform integration processing on input data of the time sequence module to obtain an integration result, a size of the integration result being different from a size of the input data of the time sequence module, and the input data of the time sequence module comprising the execution results of separate processing procedures for the plurality of frame images;
the first conversion network is configured to convert the integration result from a first expression to a second expression to obtain a first conversion result, the first expression being used for describing an image feature, and the second expression being used for describing a video feature;
the at least one self-attention network is configured to perform self-attention processing on the first conversion result to obtain a self-attention processing result;
the second conversion network is configured to convert the self-attention processing result from the second expression to the first expression to obtain a second conversion result; and
the splitting network is configured to perform splitting processing on the second conversion result to obtain a splitting result, a size of the splitting result being the same as a size of the input data of the time sequence module.

17. The electronic device according to claim 11, wherein the second video is generated using a target model;
the target model comprises at least one time sequence module; and
the instructions or the computer programs causing the electronic device to perform a training process of the target model comprise instructions to:
set part or all parameters of the at least one time sequence module in the target model to zero, and train other parts of the target model except for the at least one time sequence module according to a first image and a second image, an object described by the first image being the same as an object described by the second image; and
freeze parameters of other parts of the target model except for the at least one time sequence module, and train the at least one time sequence module in the target model according to a first image sequence and a second image sequence, an object described by the first image sequence being the same as an object described by the second image sequence.

18. The electronic device according to claim 17, wherein the time sequence module comprises a second conversion network; and
the instructions or the computer programs causing the electronic device to set part or all parameters of the at least one time sequence module in the target model to zero comprise instructions to:
set a parameter of the second conversion network of the at least one time sequence module in the target model to zero.

19. The electronic device according to claim 17, wherein the instructions or the computer programs causing the electronic device to perform a training process of the at least one time sequence module comprise instructions to:
obtain the first image sequence, the second image sequence, and label information corresponding to at least one frame image in the second image sequence;
obtain a processed sequence by performing mask processing on at least one frame image in the first image sequence, the processed sequence comprising a mask processing result of the at least one frame image, and for any frame image of the at least one frame image, information described by a mask processing result of the frame image being less than information described by the frame image;
determine prediction information corresponding to the at least one frame image in the second image sequence according to the target model, the processed sequence and the body shape parameter prediction result corresponding to the at least one frame image in the second image sequence; and
update the at least one time sequence module in the target model according to the prediction information corresponding to the at least one frame image in the second image sequence and the label information corresponding to the at least one frame image in the second image sequence.

20. A non-transitory computer-readable medium, wherein instructions or a computer program are stored in the computer-readable medium, and when the instructions or the computer program are run on a device, causing the device to:
obtain a first video, at least one frame image in the first video comprising a target object;
for any frame image in the first video, obtain a body shape parameter prediction result corresponding to the frame image by performing body shape parameter prediction processing on the frame image, the body shape parameter prediction result being used to describe a body shape of the target object in the frame image;
for any frame image in the first video, obtain a body shape parameter adjustment result corresponding to the frame image by performing adjustment processing on the body shape parameter prediction result corresponding to the frame image according to body shape adjustment information specified for the target object; and
generate a second video according to the first video and a body shape parameter adjustment result corresponding to the at least one frame image in the first video, the i-th frame image in the second video being used to represent a body shape parameter adjustment result for the i-th frame image in the first video, the i-th frame image in the second video being generated according to a plurality of frame images arranged in sequence in the first video and body shape parameter adjustment results corresponding to the plurality of frame images, a distance between an arrangement position of at least one frame image of the plurality of frame images in the first video and an arrangement position of the i-th frame image in the first video being not greater than a preset distance threshold, i being a positive integer, and i being less than or equal to a number of image frames in the second video or a number of image frames in the first video.
